(19) United States
(12) Patent Application Publication
(10) Pub. No.: US 2009/0176673 A1
(43) Pub. Date: Jul. 9, 2009

(54) COLOR-CHANGING CLEANSING COMPOSITIONS AND METHODS

(75) Inventor: Robert Eugene Hanes, Austin, TX (US)

Correspondence Address: CHALKER FLORES, LLP, 2711 LBJ FRWY, Suite 1036, DALLAS, TX, 75234, US

(73) Assignee: REVEAL SCIENCES, LLC, Austin, TX (US)

(21) Appl. No.: 12/351,669

(22) Filed: Jan. 9, 2009

Related U.S. Application Data
(60) Provisional application No. 61/020,061, filed on Jan. 9, 2008.
(60) Provisional application No. 61/044,442, filed on Apr. 11, 2008.

(51) Int. Cl. C11D 3/40

(52) U.S. Cl. 510/100

(57) ABSTRACT

The present invention provides methods, kits and compositions that are nontoxic color changing cleansers The cleansers include a mixture having a first component mixture and a second component mixture, wherein the first component mixture comprises a nontoxic color changing dye and the first component mixture in combination with the second component mixture such that the color of the nontoxic color changing dye is of a different color than the nontoxic color changing dye in the first component mixture.

### CROSS-REFERENCE TO RELATED APPLICATIONS

This application claims priority to U.S. Provisional Application Ser. Nos. 61/020,061, filed Jan. 9, 2008 and 61/044,442, filed Apr. 11, 2008, the entire contents of which are incorporated herein by reference.

### FIELD OF THE INVENTION

The invention generally relates to a cleansing composition. This invention also includes a method and kit for cleansing materials. More particularly, the invention is directed to producing color changing soaps to facilitate promotion of hygiene and proper cleansing.

### BACKGROUND OF THE INVENTION

It is often desirable to provide household toiletries such as soaps, shampoos with pleasant colors. Such colors are provided to household toiletries using dyes and pigments. Color-change has been a fascination of individual for long time. Traditionally, compounds that exhibited the ability for color change are leuco dyes. Leuco dyes are of limited use to produce materials that begin as colored and end as colorless since three components are generally required to effect the transition. Generally, a color former (the leuco dye), a developer (such as phenolic compound) and a reversible matrix, such as long chain alcohol, are combined. An often noted drawback with leuco dye systems is their water insolubility. Other limitations of leuco dye systems are commercial availability of all the colors and the cost.

Approaches ensuring effective hand cleansing include antibacterial hand rubs. One drawback with such hand rubs is that such rubs may dry hands more than washing with soaps. Another approach known involves applying a dye that glows under a black light to hands prior to washing hands followed by washing hands and then analyzing the effectiveness of hand-washing process by examining the hands under a black light. In addition, some hospitals use electronic devices that alert an employee, if the employee's hands were not effectively washed. Such approaches may be expensive and fail to achieve widespread use.

### SUMMARY OF THE INVENTION

In view of the deficiencies of the prior art, it would be highly desirable to provide a color-changing cleansing composition, method and kit using nontoxic, non-staining colorants which provides an effective cleansing. Therefore, there is a need for an effective way of cleansing the hands while providing an indication that the cleansing is easy, effective, safe and inexpensive. The current invention provides such a composition, method and kit.

There remains a need for a soap product that will give an indication of when sufficient use has occurred. It is an object of this invention to provide such a use indicating soap. Conventional soaps used for hand washing do not indicate whether the soap has been used for an appropriate amount of time for the process to be effective. As a result, hands are often washed for too short an amount of time for the process to be effective in cleansing hands. Properly washing your hands is one of the best ways to prevent infection and the spread of diseases. Doctors, nurses and other people who work in medical settings have to wash their hands frequently to avoid spreading of infective agents. Those who prepare food must keep clean hands so they do not put germs into the food they are making. Children and many adults do not always take the appropriate time needed to effectively clean their hands. It is, therefore, quite important for children and adults to spend adequate time cleaning hands and learn the correct way of completing a key hygiene task. In order for proper hand cleaning habits to form, the teaching and monitoring must be done in a non-threatening and natural manner. One way of accomplishing this would be introduce an element of fun and novelty so that children and adults enjoy completing the task while building better hygiene habits. Another way would be to give them a sense of accomplishment by providing a feedback signal they can easily understand and associate with correctly completing the task.

Separate from the interest in removing microbes from the hands for hygiene, the greater scope of the effects of antimicrobial agents upon the environment and its effects upon bacterial resistance provide a driving force through which to accomplish the former, while minimizing the latter. The object of this invention further provides a method through which proper hygiene is achieved by thorough washing for a minimum of 20 seconds using surfactants. It has been noted by “Short- And Long-Term Effects Of Handwashing With Antimicrobial Or Plain Soap In The Community” Journal of Community Health,” Vol. 28, No. 2, April 2003, sufficient hygiene can be achieved without the use of antimicrobial agents such as triclosan or quaternary ammonium salts. The invention provides color changing formulations containing both antimicrobial agents and without. Through the use of a color changing agent that works over a repeatable time window, the user confidently can use these formulations to achieve proper sanitation, without antimicrobials. The formulation without antimicrobials impact the environment by decreasing the load of antibacterial agents released into water supplies and contributing to the problem of microbial resistance. “Strange but True: Antibacterial Products May Do More Harm Than Good,” Scientific American (Jun. 7, 2007).

The present invention fulfills the above-stated objective and overcomes these problems by broadly providing color-changing soap compositions, methods and kits that can encourage proper hand washing as a way to promote good hygiene. The inventors have developed novel color-changing soap composition for various cleansing applications. It is therefore a principle object of the present invention to provide color-changing hand soap composition for effective cleansing. It is also an object of the present invention to provide novel color-changing composition, method and kit. It is a further object of the present invention to develop a new cleansing aid that provides a color-change detectible by a user after a period of time of rubbing hands together. The observable color-change may occur for a finite time, e.g., from 10 seconds to 5 minutes, or more particularly 10 to 45 seconds, or still more particularly between 25 to 35 seconds. It is an additional object of the present invention to provide a composition that changes color during use includes natural colorants, synthetic colorants, acid-base indicators, FD&C dyes, D&C dyes. In one embodiment, flavin, phthalein or sulfonephthalein or azo compounds may be used as pH indicator. It is a further object of the invention to provide functionalized thickening agents that provide improved performance (i.e., color change) and improve the safety profile of a dye through linking to a polymer. The safety profile of polymers is known in the art, for example see EPA exemptions for polymers and co-polymers over 10 kD—www.epa.gov/EPA-PEST/2002/May/Day-24/p12974.htm.

The method through which a given dye changes its color is provided for with the following embodiments:
1) A color changing hand soap that changes its color due to an decrease in pH brought about by the interaction with atmospheric carbon dioxide with the dye.
2) A surfactant composition interacting with the dye such that the surfactants control the rate through which the color changes.
3) A surfactant mixture that forms supramolecular complexes with dyes, such as a micelle which controls the rate through which the absorbance of the dye changes.
   [Absorbance is a physical quantity defined by

Absorbance (A)=−log₁₀ Transmitance (T)=log Incident Radiant Power (P₀)/Transmitted Radiant Power (P)

To the end user, the change in absorbance is observed and a change in the color visible to the human eye. Color refers to the portion of the Electromagnetic spectrum known as visible.]

Further embodied by the examples is a color changing soap formulation that changes its color by the presence of an analyte
1) In such an example, the color of the dye is perturbed by the presence of a metal ion.
2) Reversible of the color caused by the metal ion by a chelating agent such as, but not limited to EGTA, EDTA or encapsulated EDTA
3) Restoring the color removed by EDTA through an activator or encapsulated activator.
4) Further examples of analytes whose presence shifts the absorbance of the dye include small organic molecules that may be positive, negative, neutral of zwitterionic.

Other soap formulations whose colors change may be described by the formation of supramolecular complexes formed between the surfactant, the dye and the analyte. In other formulations, the supramolecular complex is formed between the dye and the surfactant. For the situations where a color is formed when the molecules self-assemble, the color modulation is brought about by a disruption caused when the user rubs the hands together causing, heat, pressure or friction to disrupt the complex.

Each of these color changing mechanisms may be further enhanced through the use of a mechanical dispenser designed to foam the soap. The rate of color change, for each of the color changing methods depends on the amount of air entrained by the roamer and the average size of the bubbles formed.

It is a further object of the present invention to provide easy, safe and inexpensive color-changing cleansing composition. Finally, it is an object of this invention to provide different color changing mechanisms to embody color on demand technology amenable to a variety on complex media, temperatures, inanimate surfaces, as well as skin and hair.

The present invention can be used in a number of settings including, but not limited to, private homes, hospitals, medical settings, children center, nursing homes, schools, restaurants, airports, food-preparation establishments, food-processing establishments, restrooms, offices, hotels/motels, labs, and commercial places.

More particularly, in one embodiment the present invention is a nontoxic color changing cleanser composition comprising: a cleanser mixture comprising a first component mixture and a second component mixture, wherein the first component mixture comprises a nontoxic color changing dye and the first component mixture in combination with the second component mixture such that the color of the nontoxic color changing dye is of a different color than the nontoxic color changing dye in the first component mixture. In one aspect, the pH is different in the first component mixture in combination with the second component mixture than in the pH in the first component mixture. In another aspect, an analyte concentration is different in the first component mixture in combination with the second component mixture than in the first component mixture. In one aspect, the nontoxic color changing dye is an anthocyanin compound. In yet another aspect, the composition further comprises an antibacterial composition, an antimicrobial compound, an antibiotic, a lipid composition, nanoparticles, metals, or mixtures thereof. In another aspect, the cleanser mixture changes its color due to a decrease in pH upon exposure to atmospheric carbon dioxide.

The cleanser mixture may also comprise one or more surfactants in contact with the dye, wherein the one or more surfactants are selected to change the speed of a color change in the dye. The cleanser mixture may also comprise one or more surfactants in contact with the dye, wherein the surfactant and dye form a mixture that comprises supramolecular complexes that controls the rate through which the absorbance of the dye changes. In another aspect, the cleanser mixture may also comprise a metal ion, wherein the color of the dye is different in the presence of the metal ion.

In one aspect, the cleanser mixture comprises at least one color reversible dye, wherein the dye color is reduced in the presence of a metal ion and the color change is controlled by one or more chelating agents that chelate the metal ion. The chelating agent may be selected from at least one of EGTA, EDTA or encapsulated EDTA. For example, the color of the cleanser mixture is restored by removing the metal upon release or activation of a chelator. In another aspect, the dye activates in the presence of one or more analytes that shifts the absorbance of the dye, wherein the analyte is selected from small organic molecules that may be positive, negative, neutral of zwitterionic. In one aspect, the first or the second composition further comprise a biopolymer, wherein a toxicity of the dye is reduced by chemical attachment to the biopolymer. In another aspect, the toxicity of the dye is reduced upon chemical attachment to the biopolymer.

In yet another embodiment, the present invention is a nontoxic color changing cleanser kit comprising: a first component mixture; and a second component mixture, wherein the first component mixture comprises a nontoxic color changing dye and the first component mixture in combination with the second component mixture such that the color of the nontoxic color changing dye is of a different color than the nontoxic color changing dye in the first component mixture. In one aspect, the pH is different in the first component mixture in combination with the second component mixture from the pH in the first component mixture. In another aspect, the nontoxic color changing dye is an anthocyanin compound.

Yet another embodiment of the present invention is a color changing cleanser composition comprising: a cleanser having a calorimetric dye disposed therein, wherein the pH affects the color of the calorimetric dye and a change in the pH results in a change in the color of the calorimetric dye. Another embodiment of the present invention is a nontoxic color changing cleanser composition comprising a cleanser mixture comprising a first component mixture and a second component mixture, wherein the first component mixture comprises an nontoxic color changing anthocyanin dye and the first component mixture in combination with the second component mixture such that the color of the nontoxic color changing anthocyanin dye is of a different color than the nontoxic color changing anthocyanin dye in the first component mixture.

Yet another aspect of the present invention of the present invention includes a method of making a nontoxic color changing cleanser composition comprising making a cleanser mixture comprising mixing separately a first component mixture and a second component mixture, wherein the first component mixture comprises a nontoxic color changing dye and the first component mixture in combination with the second component mixture such that the color of the nontoxic color changing dye is of a different color than the nontoxic color changing dye in the first component mixture, wherein upon contact between the first and second component the cleanser mixture changes color.

The details of one or more embodiments of the invention are set forth in the description below. Other features, objects and advantages of the invention will be apparent from the description and from the claims.

### BRIEF DESCRIPTION OF THE DRAWINGS

For a more complete understanding of the features and advantages of the present invention, reference is now made to the detailed description of the invention along with the accompanying figures and in which:

FIG. 1 shows an example of a dye attached to a biopolymer (Guar).

FIG. 2 details the chemical reactions and protocol for attaching a dye to a polymer.

### DETAIL DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Use of the singular herein includes the plural and visa versa unless expressly stated to be otherwise. That is, “a” and “the” refer to one or more of whatever the word modifies. For example, “a colorant” includes one such agent, two such agents, etc. Likewise, “the layer” may refer to one, two or more layers and “the polymer” may mean one polymer or a plurality of polymers. By the same token, words such as, without limitation, “layers” and “polymers” would refer to one layer or polymer as well as to a plurality of layers or polymers unless, again, it is expressly stated or obvious from the context that such is not intended.

In general, a composition for indicating whether hands have been washed for an appropriate predetermined period of time includes natural and synthetic color-changing colorants which may change color by various mechanisms. The colored cleansing composition can be delivered in the form of a body wash, such as a liquid hand soap, shower gel, a shampoo or a bar soap. The compositions change color from colored to colorless, colorless to colored, one color to another color or one color to second color to third color.

As used herein, the term “surfactant” is recognized in the relevant art to include those compounds which modify the nature of surfaces, e.g., reducing the surface tension of water.

Surfactants or surface active agents are amphiphatic in nature, having polar hydrophilic head and non-polar, hydrophobic straight or branched tail. Therefore, they are soluble in water and organic solvents. Surfactants can be wetting agent or foamers. Surfactants lower the surface tension of the medium in which it is dissolved. Surfactants are generally classified by the presence of the charged groups in their head, into four types: anionic surfactants, cationic surfactants, amphoteric or zwitterionic surfactants and non-ionic surfactants.

As used herein, an “anionic surfactant” refers to a surfactant having a head carrying a negative charge, e.g., alkyl, aryl, alkylaryl, linear, branched, sulfates, sulfonates, carboxylates, phosphates, soaps, fatty acids.

As used herein, a “cationic surfactant” refers to a surfactant having a head carrying a positive charge, e.g., quaternary ammonium salts or modified onium salts, where part of the molecule is hydrophilic and the other is straight or branched long hydrocarbon chains such as hexadecyltrimethyl bromide.

As used herein, a “amphoteric or zwitterionic or ampholytic surfactant” refers to a surfactant having a head carrying either a positive charge or a negative charge or no-charge in solution depending on the pH of the water. (e.g., betaines, glycinates). They are compatible with all other classes of surfactants and are soluble and effective in the presence of high concentrations of electrolytes, acids and alkalis.

As used herein, a “non-ionic surfactant” refers to a surfactant having a head carrying no electrical charge. (e.g., polyethylene oxide, ethers, fatty alcohols, glucosides, amides). One or more surfactants can be used in the present invention.

As used herein a “colorant” refers to a compound or a chemical which imparts color. Colorants can be natural and synthetic. Natural colorants occur in nature, mainly in plants, vegetables and fruits. Synthetic colorants are synthesized in a laboratory. Colorants can be dyes or pigments.

As used herein, the term “biopolymer” refers to low, medium and high molecular weight organic compounds such as polysaccharides, and combinations of polysaccharides with other organic molecules. The biopolymers may be natural or synthetic, hydrophobic or hydrophilic, biodegradable, biocompatible, homopolysaccharides or heteropolysaccharides, or combinations thereof. Examples of sources for biopolymers include, e.g., gum tragacanth, guar gum, grain flour, rice flour, sugar cane, beet sugar, potato, milk, agar, algin, locust bean gum, psyllium, karaya gum, seed gums, Larch tree extract, aloe vera extract, gum ghatti, starch, cellulose, degraded cellulose, fructose, high fructose corn syrup, pectin, chitin, acacia, gum arabic, alginic acid, carrageenan, dextran, xanthan gum, chondroitin sulfate, acetylated polymannose, maltose, glucan, lentinan, mannan, levan, hemi-cellulose, inulin, and fructan. Examples of natural sources of biopolymers include: (a) shrub or tree exudates which contain acacia, karaya, tragacanth, or ghatti; (b) marine gums which include agar, algin, or carrageenan; (c) seed gums which include guar, locust bean, or psyllium; (d) plant extracts which contain pectins or acetylated polymannose; (e) starch and cellulose derivatives such as hetastarch, carboxymethylcellulose, ethylcellulose, hydroxypropyl methylcellulose, methylcellulose, oxidized cellulose; and microbial gums which contain dextrans, xanthan. However, it should be recognized that the composition of the invention is not intended to be limited by the source from which the respective carbohydrates are obtained.

As used herein, the “dyes” refers to compounds or substances which impart color when dissolved in a medium, thus dyes are soluble in a medium. The medium can be water or organic solvents. The dyes can be organic, organo-metallic or inorganic.

As used herein, the “pigments” refers to compounds or substances which impart color when dispersed in a medium. The pigments are insoluble in a medium. The medium can be water or organic solvents. The pigments are sold as large particles, i.e., in the form of agglomerates and aggregates. The pigments are broken down into their primary particle size and are stabilized in their primary particle size. The process is called pigment dispersion. The pigments can be organic, organo-metallic or inorganic.

As used herein, the “amphoteric surfactants” refer to 1) molecules that contain both acidic and basic sites such as, e.g., an amino acid containing both amino (basic) and acidic (carboxylic) functional groups; or 2) zwitterionic molecules which possess both positive and negative charges within the same molecules. The charges of latter may be either dependent on or independent of the pH of the composition. One skilled in the art would readily recognize that under the pH conditions of the compositions of the present invention, the amphoteric surfactants are either electrically neutral by virtue of having balancing positive and negative charges, or they have counter ions such as alkali metal, alkaline earth or ammonium counter ions.

As used herein, unless otherwise specified, the term “antimicrobial” describes a biocidal effect that may be, for example, an antibacterial, antifungal, antiviral, bacterio-static, disinfecting or sanitizing effect. Representative examples of antimicrobial agents include, but are not limited to, benzyl alcohol, lactic acid, salicylic acid, iodophores, quaternary ammonium compounds, hypochloride releasing compounds (e.g., alkali hypochloride, hypochlorous acid), oxidizing compounds (e.g., hydrogen peroxide, peracids, hypochlorite), protonated carboxylic acid (e.g., heptanoic acid, octanoic acid, nonanoic acid, decanoic acid, undecanoic acid), Irgasan and Irgasan DP 300, manufactured by Ciba Specialty Chemicals; Nipacide, Nipacide PX-P, Triclosan and mixtures thereof.

As used herein, the “humectants” refer to chemicals which help to retard the evaporation of water from the composition, thus avoiding premature drying during the application. Representative examples of humectants include, but are not limited to, glycerin, ethylene glycol, propylene glycol, diethylene glycol, polyethylene glycol, hydroxylated statches, sorbitol, gelatin, sodium 2-pyrrolidone-5-carboxylate, soluble collagen, dibutyl phthalate and mixtures thereof. Any effective amount of humectants may be used.

Non-limiting examples of anionic, cationic, zwitterionic or amphoteric and non-ionic surfactants that are suitable for use in present invention are described in Kirk-Othmer Encyclopedia of Chemical Technology (2006) and McCutcheon's Emulsifiers and Detergents, Volume 1, North American Edition (2007), both of which are incorporated herein by reference.

Anionic surfactants can be useful for obtaining foaming and cleaning properties. According to certain embodiments, suitable anionic surfactants include, but are not limited to, linear or branched alkyl sulfates, alkyl alkoxysulfates, alkyl ether sulfates, alkyl monoglyceryl ether sulfates, alkyl sulfonates, alkylaryl sulfonates, alkyl ester sulfonates, olefin sulfonates, alkyl glycerol sulfonates, fatty acyl glycerol sulfonates, fatty oleyl glycerol sulfonates, alkyl sulfosuccinates, alkyl ether sulfosuccinates, alkyl sulfosuccinamates, alkyl amidosulfosuccinates, alkyl carboxylates, alkyl amidoethercarboxylates, alkyl alkoxy carboxylates, soaps, 2-methyl-1-undecanoic acid, 2-ethyl-1-decanoic acid, 2-propyl-1-nonaoic acid, 2-butyl-1-octanoic acid, 2-pentyl-1heptanoic acid, alkyl succinates, fatty acyl sarcosinates, myristyl sarcosinates and its salts, oleoyl methyl sarcosinates and its salts, fatty acyl amino acids, fatty acyl taurates, fatty alkyl sulfoacetates, lauryl sulfoactates and its salts, myristyl sulfoacetates and its salts, sulfated fatty acid esters, alkyl phosphates, and mixtures thereof. In some embodiments, the anionic surfactants of the present invention include, but are not limited to, salts including sodium, potassium, ammonium, calcium, magnesium, monoethanolammonium, diethanolammonium, triethanolammonium salts of the anionic sulfate, sulfonate, sulfosuccinates, sulfoacetates, carboxylates, sarcosinates, phosphates and mixtures thereof. Other anionic surfactants useful in the present invention include, but are not limited to, alpha sulfonated alkyl ester, phthalates, N,N-disubstituted phthalamic acids, esters and their salts, phosphate esters and mixtures thereof. Examples of certain preferred anionic surfactants include, but are not limited to, as given by the following formulas:

alkyl sulfates of the formula:

R—CH₂OSO₃X;

alkyl ether sulfates of the formula:

R(OCH₂CH₂)_{y}OSO₃X;

alkyl monoglyceryl ether sulfates of the formula:

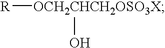

alkyl monoglyceride sulfates of the formula:

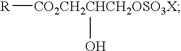

alkyl sulfonates of the formula:

R—SO₃X;

alkyl monoglyceride sulfonates of the formula:

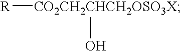

alkyl aryl sulfonates of the formula:

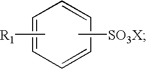

alkyl sulfosuccinates of the formula:

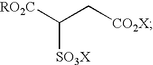

alkyl ether sulfosuccinates of the formula:

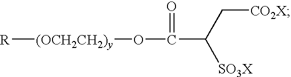

alkyl sulfosuccinamates of the formula:

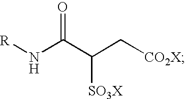

alkyl amidosulfosuccinates of the formula:

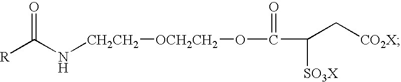

alkyl carboxylates of the formula:

R—(OCH₂CH₂)_{Z}—OCH₂CO₂X;

alkyl amidoethercarboxylates of the formula:

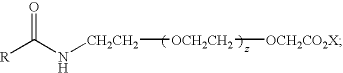

alkyl succinates of the formula:

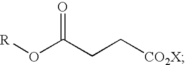

fatty acyl sarcosinates of the formula:

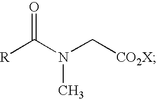

fatty acyl amino acids of the formula:

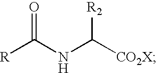

fatty acyl taurates of the formula:

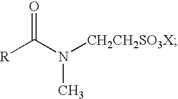

fatty alkyl sulfoacetates of the formula:

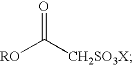

alkyl phosphates of the formula:

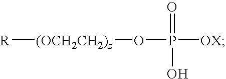

wherein

R=alkyl group having from about 6 to about 25 carbon atoms;

R₁=alkyl group having from about 1 to about 20 carbon atoms;

R₂=substituent of natural or synthetic I-amino acid;

X=alkali metal ions, alkaline earth metal ions, ammonium ions, ammonium ions substituted with from about 1 to about 3 substituents: substituents may be same or different, consisting alkyl group having from about 1 to about 5 carbon atoms and hydroxyalkyl group having from about 2 to about 5 carbon atoms;

y=an integer from about 1 to about 8;

z=an integer from about 0 to about 20;

and mixtures thereof.

In some embodiments, the sulfate surfactants of the present invention include, but are not limited to, sodium laureth sulfate, Steol CS-330, Steol CS-460, sodium coco-sulfate, Stepanol DCFAS-F, Stepanol DCFAS-N, manufactured by Stepan Co., Northfiled, Ill.; ammonium lauryl sulfate, Colonial ALS, sodium lauryl sulfate, Colonial SLS, manufactured by Colonial Chemical Inc, S. Pittsburgh, Tenn. In other embodiments, the sulfonate surfactants of the present invention include, but are not limited to, sodium olefin sulfonate, BioTerge AS-40, manufactured by Stepan Co., Northfiled, Ill.

Cationic surfactants can be useful as surface tension reducing agents. According to certain embodiments, suitable cationic surfactants include, but are not limited to, fatty amine salts, fatty diamine salts, polyamine salts, quaternary ammonium salts, polyoxyethyleneated fatty amine salts, quartemized polyoxyethyleneated fatty amines and mixtures thereof.

Cationic surfactants in the form of quaternary ammonium salts include mono-long chain alkyl, tri-short chain alkyl ammonium halides, wherein long chain alkyl group has from about 8 to about 25 carbon atoms and is derived from long chain fatty acids, and wherein short chain alkyl group has from about 1 to about 7 carbon atoms. Examples of quaternary ammonium salts useful herein include, but are not limited to, cetyl trimethyl ammonium bromide (CTAB), lauryl trimethyl ammonium chloride, octyltrimethyl ammonium chloride, decyltrimethyl ammonium chloride, dodecyltrimethyl ammonium chloride, dodecyltrimethyl ammonium bromide.

Salts of primary, secondary and tertiary fatty amines are also suitable cationic surfactant material of the present the present invention. The alkyl group of such amine salts preferably have from about 10 to about 25 carbon atoms which may be substituted or unsubstituted. Secondary and tertiary amine salts are preferred in the present invention. Examples of amine salts include, but are not limited to, fluoride, chloride, bromide, acetate, phosphate, nitrate, lactate and alkyl sulfate salts. Amine salts derived from amine include, but are not limited to, stearamido, propyl dimethyl amine, diethyl amino ethyl stearamide, dimethyl stearamine, dimethyl soyamine, soyamine, myristyl amine, tridecyl amime, ethyl stearylamine, N-tallopropane diamine, ethoxylated stearylamine, dihydroxyethyl stearylamine, arachidylbehenylamine, stearylamine hydrogen chloride, soyamine chloride, stearylamine formate, N-tallowpropane diamine chloride, stearylamidopropyl dimethylamine citrate and mixtures thereof.

In addition to the above, cationic surfactants particularly useful herein are those of the general formula:

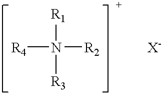

R₁=alkyl, benzyl

R₂=alkyl, benzyl

R₃=alkyl, benzyl

R₄=alkyl group having C₆ to C₂₀;

X=anion include, but not limited to, halogen, sulfate, methosulfate, ethosulfate, sulfonate or carboxylate, acetate, nitrate, phosphate, saccharinate or tosylate.

Other quaternary ammonium compounds and amine salts of the above general formula in the form of ring structures formed by covalently linking two of the radicals which may include heteroatom. Examples of such quaternary ammonium compounds and amine salts include, but are not limited to, imidazolines, imidazoliniums, pyridiniums, 2-heptadecyl-4,5-dihydro-1H-imidazol-1-ethanol, 4,5-dihydro-1-(2-hydroxyethyl)-2-isoheptadecyl-1-phenylmethyl-imidazolium chloride, 1-[2-oxo-2-[[2-(1-oxoctadecyl)oxy]ethyl]amino]ethyl-pyridinium chloride.

Other cationic surfactants include those compounds commonly referred to as “ester quats”, and as disclosed in U.S. Pat. No. 5,939,059, which is incorporated herein by reference.

Typically, such materials are of general formula:

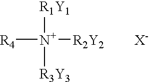

wherein

X=an anion;

R₁, R₂, R₃=same or different, straight or branched chain alkyl group from about C₂ to about C₈;

R₄=saturated or unsaturated, straight or branched chain alkyl group from about C₁ to about C₁₀, optionally substituted with halogen, hydroxyl, epoxy;

Y₁, Y₂, Y₃=same or different, H, OH, aliphatic ester having saturated or unsaturated, straight or branched chain alkyl group from about C₁₀ to about C₂₅.

Further, cationic surfactants can also be antimicrobial compounds of the formula:

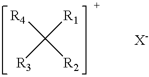

wherein

R₁, R₂=straight or branched chain having lower alkyl group from about C1 to about C8;

R₃=straight or branched chain having higher alkyl group from about C8 to about C25, benzyl group or substituted benzyl group;

R4=straight or branched chain having higher alkyl group from about C8 to about C25;

X=anion include, but not limited to, halogen, sulfate, methosulfate, ethosulfate, sulfonate or carboxylate, acetate, nitrate, phosphate, saccharinate or tosylate.

In certain embodiments, examples of antimicrobial quaternary ammonium salts useful herein include, but are not limited to, dioctyl dimethyl ammonium chloride, octyl decyl dimethyl ammonium chloride, didecyl dimethyl ammonium chloride, n-alkyl dimethyl benzyl ammonium chloride (C12-C20), n-alkyl dimethyl benzyl ammonium bromide (C12-C20), n-alkyl dimethyl ethylbenzyl ammonium chloride (C12-C20), n-alkyl dimethyl ethylbenzyl ammonium bromide (C12-C20), n-alkyl dimethyl benzyl ammonium chloride (C12-C20), n-alkyl dimethyl benzyl ammonium bromide (C12-C20), n-alkyl dimethyl benzyl ammonium saccharinate (C12-C20), n-tetradecyl dimethyl benzyl ammonium chloride monohydrate, dialkyl dimethyl ammonium chloride, dialkyl dimethyl ammonium bromide, and mixtures thereof. This is not an exhaustive list and other quaternary ammonium salts having antimicrobial activity will suffice. The quaternary ammonium salt in the present invention need not be a single entity, but may be a blend of two or more quaternary ammonium salts.

Amphoteric or zwitterionic surfactants can be useful because of their solubility and compatibility with other surfactants. According to certain embodiments, suitable amphoteric or zwitterionic surfactants include, but are not limited to, amphocarboxylates, amphophosphates, phosphorylated imidazolines, caboxyalkyl alkylpolyamines, alkylimino-dipropionates, propionates, amphoacetates, amphoalkyl sulfonates, sarcosinates, imidazolines, cocyl imidazoline, lauryl imidazoline, stearyl imidazoline, behenyl imidazoline, behenylhydroxyethyl imidazoline, alkyl glycinates, alkylamphoglycinates, cocoamphoglycinate, lauramphoglycinate, cocoamphocarboxyglycinate, lauramphocarboxyglycinate, stearamphoglycinate, tallowamphoglycinate, oleoamphoglycinate, caproamphoglycinate, caprylamphoglycinate, caprylamphocarboxyglycinate, caprylamphopropyl sulfonate, cocamphopropyl sulfonate, stearamphopropyl sulfonate, oleoamphopropyl sulfonate, cocoamphopropionate, cocoamphocarboxypropionate, tallowamphopropionate, alkyl betaines, amidoalkyl betaines, phosphobetaines, pyrophosphobetaines, sulfobetaines, alkyl sultaines, amidoalkyl sultaines, and mixtures thereof.

Examples of certain preferred amphoteric or zwitterionic surfactants include, but are not limited to, as given by the following formulas:

Amphocarboxylates of the formula:

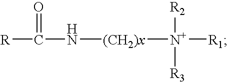

wherein

R=alkyl or alkenyl group having from about C₅ to about C₂₂;

R₁=hydrogen or carboxyalkyl group having from about C₂ to about C₅;

R₂=hydroxyalkyl group having from about C₂ to about C₅;

R₃=carboxyalkyl group having from about C₂ to about C₅;

x=an integer from about 2 to about 8.

Amphophosphates of the formula:

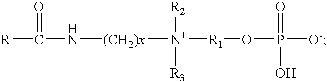

wherein

R=alkyl or alkenyl group having from about C₅ to about C₂₂;

R₁=alkylene or hydroxyalkylene group having from about C₂ to about C₅;

R₂=hydrogen or carboxyalkyl group having from about C₂ to about C₅;

R₃=hydroxyalkyl group having from about C₂ to about C₅;

x=an integer from about 2 to about 8.

Alkyl betaines of the formula:

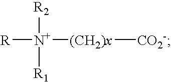

wherein

R=alkyl or alkenyl group having from about C₅ to about C₂₂;

R₁=hydrogen or carboxyalkyl group having from about C₂ to about C₅;

R₂=hydroxyalkyl group having from about C₂ to about C₅;

x=an integer from about 2 to about 8.

Amidoalkyl betaines of the formula:

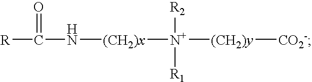

wherein

R=alkyl or alkenyl group having from about C₅ to about C₂₂;

R₁, R₂=alkyl or hydroxyalkyl group having from about C₁ to about C₅;

x=an integer from about 2 to about 8.

Phosphobetaines of the formula:

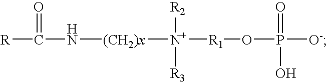

wherein

R=alkyl or alkenyl group having from about C₅ to about C₂₂;

R₁=alkylene or hydroxyalkylene group having from about C₂ to about C₅;

R₂=hydrogen or carboxyalkyl group having from about C₂ to about C₅;

R₃=hydroxyalkyl group having from about C₂ to about C₅;

x=an integer from about 2 to about 8.

In one embodiment, the phosphobetaine compounds are those disclosed in U.S. Pat. Nos. 4,215,064, 4,617,414, 4,233,192, which are all incorporated herein by reference.

Pyrophosphobetaines of the formula:

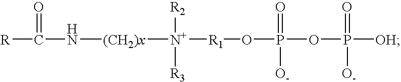

wherein

R=alkyl or alkenyl group having from about C₅ to about C₂₂;

R₁=alkylene or hydroxyalkylene group having from about C₂ to about C₅;

R₂=hydrogen or carboxyalkyl group having from about C₂ to about C₅;

R₃=hydroxyalkyl group having from about C₂ to about C₅;

x=an integer from about 2 to about 8.

In other embodiment, the pyrophosphobetaine compounds are those disclosed in U.S. Pat. Nos. 4,382,036; 4,617,414; and 4,372,869, which are all incorporated herein by reference.

Amidoalkyl sultaines of the formula:

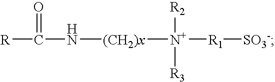

wherein

R=alkyl or alkenyl group having from about C₅ to about C₂₂;

R₁=alkylene or hydroxyalkylene group having from about C₂ to about C₅;

R₂, R₃=alkyl or hydroxyalkyl group having from about C₁ to about C₅;

x=an integer from about 2 to about 8.

Carboxyalkyl alkylpolyamines of the formula:

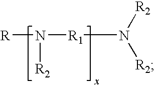

wherein

R=alkyl or alkenyl group having from about C₅ to about C₂₂;

R₁=alkylene group having from about C₂ to about C₅;

R₂=carboxyalkyl group having from about C₂ to about C₅;

x=an integer from about 1 to about 5.

In some embodiments, the amphoteric surfactants of the present invention include, but are not limited to, cocamidopropyl betaine, Amphosol CA, Amphosol CG, Amphosol HCA, Amphosol HCG, manufactured by Stepan Co., Northfiled, Ill.; sodium lauroamphoacetate, ColaTerric SLAA, cocamidopropyl betaine, ColaTerric COAB, natural oil derived phospholipids, ColaLipid C, manufactured by Colonial Chemical Inc, S. Pittsburgh, Tenn.

Nonionic surfactants can be useful for obtaining desirable flow and foam boost properties. According to certain embodiments, suitable nonionic surfactants include, but are not limited to, polyhydroxy, polyalkyloxy compounds such as ethylene glycol, propylene glycol, butylenes glycol, glycerin, alkyl-propanediol, mannitol, corn-syrup, diethylene glycol, dipropylene glycol, polyethylene glycol, polypropylene glycol, other polyhydroxy derivatives and mixtures thereof.

Other suitable nonionic surfactants include, but are not limited to, ethylene oxide, propylene oxide, alkyl polyethylene oxide, alkyl polypropylene oxide, copolymers of poly(ethylene oxide), poly(propylene oxide), amine oxides, phosphine oxides, sulfoxides, ethoxylated oxides, linear or branched oxides, their derivatives and mixtures thereof.

Additionally, suitable nonionic surfactants include, but are not limited to, amides, alkanolamides, cocamide, their derivatives and mixtures thereof.

In some embodiments, the alkanolamide surfactants of the present invention include, but are not limited to, cocamide DEA, ninol 40-CO, lauryl diethanolamide, ninol 30-LL, lauramide DEA, ninol 55-LL, manufactured by Stepan Co., Northfiled, Ill.; cocamide DEA, ColaMid C, lauramide DEA, ColaMid AL, ColaMid 0071, manufactured by Colonial Chemical Inc, S. Pittsburgh, Tenn.

Another class of suitable nonionic surfactants include, but are not limited to, long chain alkyl polyglucosides, which are the condensation product of a) a long chain alcohol containing from about 6 to about 25 carbon atoms, with glucose or glucose containing polymer. Presently preferred glucosides are decyl glucoside, octyl glucoside, and decyl maltoside.

In some embodiments, the blend of surfactants of the present invention include, but are not limited to, sodium laureth sulfate, sodium lauryl sulfate, lauramide DEA, cocamide DEA, cocamidopropyl betaine, Stepanol ABHS-15C, manufactured by Stepan Co., Northfiled, Ill.

While any compound or any chemical capable of changing color as set forth herein may be used as colorant to construct the color-changing cleansing composition, the process of color-change in the present invention may be achieved by various mechanisms or using different color-changing agents which include, but are not limited to, natural colorants, synthetic colorants, food/cosmetics grade dyes (FD&C, D&C dyes), acid-base indicators, oxidation-reduction indicators, luminescent indicators, thermochromic compounds using heat, photochromic compounds using light, piezochromic compounds using pressure, pigments, organic compounds, inorganic compounds, organo-metallic compounds, metals, encapsulation mechanism, self-assembled mechanism or any other color-changing component or any component changing color by any mechanism. One of ordinary skilled in the art may recognize that the scope of the invention may not be limited to the above list but any color-changing component or any color-change mechanism may be incorporated herein.

Representative examples of natural colorants (some are exempt from certification and certification varies from US, EU and Japan) of the present invention include, but are not limited to, annatto extract, anthocyanines, betalains, carrot oil, β-carotene, β-apo-8′-carotenal, canthaxanthene, caramel, carmine, cochineal extract, gardenia yellow, dehydrated beets, grape skin extract, guanine, lac, riboflavin, monascus, vegetable juices, paprika, paprika oleoresins, saffron, turmeric, turmeric oleoresin, carthamin, iridoids, phycobilins, chlorophylls (chlorophyll a, chlorophyll b, chlorophyll c, chlorophyll d, chlorophyll e), haems, chromium hydroxide green, chromium oxide greens, carbon black, talc, titanium dioxide, ultramarines, ultramarine blue, iron oxides, zinc oxide, calcium carbonate, silver, silicon dioxide and mixtures thereof.

Representative examples of carotenoids natural colorants of the present invention include, but are not limited to, antherxanthin, astaxanthin, β-apo-8′-caroten-8′-al, β-apo-8′-caroten-8′-oic acid ethyl or methyl ester, astaxanthin, bixin, canthaxanthin, capsanthin, capsorubin, α-carotene, β-carotene, citroxanthin, crocetin, β-cryptoxanthin, fucoxanthin, lactucaxanthin, lutein, lycopene, neoxanthin, norbixin, phytoene, phytofluene, violaxanthin, zeaxanthin and mixtures thereof.

As used herein, the term “anthocyanins” is recognized in the relevant art as anthocyanidins plus sugars. Representative examples of anthocyanidins of the present invention include, but are not limited to, apigeninidin, aurantindin, capensinidin, cyanidin, delphinidin, europinidin, hirsutidin, luteolinidin, pelargonidin, malvidin, peonidin, petunidin, pulchellidin, rosinidin, triacetidin and mixtures thereof.

Examples of certain preferred anthocyanidins include, but are not limited to, as given by the following general formula:

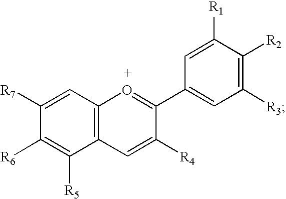

wherein

| Anthocyanidin | R₁ | R₂ | R₃ | R₄ | R₅ | R₆ | R₇ |
|---|---|---|---|---|---|---|---|
| Apigeninidin | —H | —OH | —H | —H | —OH | —H | —OH |
| Aurantindin | —H | —OH | —H | —OH | —OH | —OH | —OH |
| Capensinidin | —OCH₃ | —OH | —OCH₃ | —OH | —OCH₃ | —H | —OH |
| Cyanidin | —OH | —OH | —H | —OH | —OH | —H | —OH |
| Delphinidin | —OH | —OH | —OH | —OH | —OH | —H | —OH |
| Europinidin | —OCH₃ | —OH | —OH | —OH | —OCH₃ | —H | —OH |
| Hirsutidin | —OCH₃ | —OH | —OCH₃ | —OH | —OH | —H | —OCH₃ |
| Luteolinidin | —OH | —OH | —H | —H | —OH | —H | —OH |
| Pelargonidin | —H | —OH | —H | —OH | —OH | —H | —OH |
| Malvidin | —OCH₃ | —OH | —OCH₃ | —OH | —OH | —H | —OH |
| Peonidin | —OCH₃ | —OH | —H | —OH | —OH | —H | —OH |
| Petunidin | —OH | —OH | —OCH₃ | —OH | —OH | —H | —OH |
| Pulchellidin | —OH | —OH | —OH | —OH | —OCH₃ | —H | —OH |
| Rosinidin | —OCH₃ | —OH | —H | —OH | —OH | —H | —OCH₃ |
| Triacetidin | —OH | —OH | —OH | —H | —OH | —H | —OH |

The term “FD&C” and “D&C” dyes are recognized in the art. In the United States, colorants for food, drug and cosmetics are regarded as “color additives”. The Federal Food, Drug & Cosmetic (FD&C) Act of 1938 made food color additives certification mandatory. Since then Food and Drug Administration (FDA) has been responsible for regulating all color additives used in food, drugs and cosmetics. Each batch to be sold in the United States has to be certified by the FDA. To avoid confusing color additives used in food with those manufactured for other uses, three categories of certifiable color additives were created: 1) FD&C (Food, Drugs & Cosmetics) color additives with application in food, drugs & cosmetics; 2) D&C (Drugs & Cosmetics) color additives with application in drugs & cosmetics; 3) External D&C (External Drugs & Cosmetics) color additives with applications in externally applied drugs & in externally applied cosmetics. Lakes are colorants prepared by precipitating a soluble colorant onto an insoluble base or substratum. A variety of bases such as alumina, titanium dioxide, zinc oxide, talc, calcium carbonate and aluminum benzoate are approved for D&C colorants, while only alumina is permitted as the substrate for manufacturing FD&C lakes. The use of all food colors approved for use in the United States are listed in 21 C.F.R. (Code of Federal regulations), parts 70 through 82 dealing with color additives.

Representative examples of FD&C dyes, D&C dyes, Ext. D&C dyes for use with the present invention include, but are not limited to, FD&C Blue 1, FD&C Blue 2, FD&C Green 3, FD&C Red 3, FD&C Red 4, FD&C Red 40, FD&C Yellow 5, FD&C Yellow 6, Citrus Red 2, Orange B, D&C Blue 4, D&C Blue 6, D&C Blue 9, D&C Brown 1, D&C Green 5, D&C Green 6, D&C Green 8, D&C Orange 4, D&C Orange 5, D&C Orange 10, D&C Orange 11, D&C Red 6, D&C Red 7, D&C Red 17, D&C Red 21, D&C Red 22, D&C Red 27, D&C Red 28, D&C Red 30, D&C Red 31, D&C Red 33, D&C Red 34, D&C Red 36, D&C Red 39, D&C Violet 2, D&C Yellow 7, D&C Yellow 8, D&C Yellow 10, D&C Yellow 11, Ext. D&C Violet 2, Ext. D&C Yellow 7, [phthalocyaninato(2)]copper and mixtures thereof.

Representative examples of azo acid-base indicators of the present invention include, but are not limited to, Acid Blue 89, Acid Blue 92, alizarin yellow GG, alizarin yellow R, benzopurpurin B, benzyl orange, brilliant yellow, calmagite, carbazol yellow, chrome orange GR, chrysoidin, congo red, 4-dimethylamino-2-methylazobenzene, Direct Blue 72, ethyl orange, ethyl red, lanacyl violet BF, metanil yellow, methyl orange, methyl red, methyl red, sodium salt, methyl yellow, a-naphthyl red, nitrazine yellow, orange II, 4-(phenylazo)diphenylamine, propyl Red, solochrome violet RS, thiazol yellow G, tropaeolin O, tropaeolin OO, tropaeolin OOO and mixtures thereof.

Representative examples of benzein acid-base indicators of the present invention include, but are not limited to, benzaurin, o-cresolbenzein, dibromothymolbenzein, α-naphtholbenzein, phenolbenzein, thymolbenzein and mixtures thereof.

Representative examples of fluorescent acid-base indicators of the present invention include, but are not limited to, acridine, 9-amino-6-chloro-2-methoxyacridine, 5-aminosalicylic acid, anthranilic acid, calcein, 5-carboxy-2′,7′-dichlorofluorescein, 6-carboxy-2′,7′-dichlorofluorescein, 5-carboxy-2′,7′-dichlorofluorescein diacetate, 6-carboxy-2′,7′-dichlorofluorescein diacetate, 5-carboxyfluorescein, 6-carboxyfluorescein, 5-carboxyfluorescein diacetate, 6-carboxyfluorescein diacetate, 5(6)-carboxyfluorescein diacetate succinimidyl ester, 5-carboxynaphthofluorescein, 6-carboxynaphthofluorescein, 5-carboxynaphthofluorescein diacetate, carboxy SNAFL 1, carboxy SNAFL 2, carboxy SNAFL 1 diacetate, 5-chloromethylfluorescein diacetate, coumarin, dichlorofluorescein, 6,7-dihydroxycoumarin, 3,6-dihydroxyphthalimide, eosin Y, erythrosin B, fluorescein, fluorescein diacetate, fluorescein disodium salt, fluorescein-5-isothiocyanate, fluorescein-5-sulfonic acid, fluorescein-6-sulfonic acid, gallein, harmine, 4-heptadecyl-7-hydroxycoumarin, luminol, lysoSensor blue DND 167, lysoSensor blue DND 192, lysoSensor green DND 189, lysoSensor yellow/blue DND 160, magdala Red, 2-methoxybenzaldehyde, 4-methylesculetin, 4-methylumbelliferone, α-naphthoic acid, β-naphthol, naphthol AS, α-naphthylamine, β-naphthylamine, nigericin, oregon green 488 carboxylic acid, oregon green 500 carboxylic acid, oregon green 514 carboxylic acid, oregon green 488 carboxylic acid diacetate, o-phenylenediamine, p-phenylenediamine, phloxine B, quinine, quininic acid, resorufin, rhodol green, salicylic acid, umbelliferone and mixtures thereof.

Representative examples of nitro acid-base indicators of the present invention include, but are not limited to, dinitrocresol, α-dinitrophenol, β-dinitrophenol, γ-dinitrophenol, ε-dinitrophenol, δ-dinitrophenol, dinitrothymol, ethyl-bis(2,4-dinitrophenyl)-acetate, isopicramic acid, martius Yellow, nitramine, p-nitrobenzhydrazide, p-nitrobenzyl cyanide, 4-nitrocatechol, o-nitrophenol, m-nitrophenol, p-nitrophenol, picric acid, trinitrobenzene, trinitrobenzoic acid, trinitrotoluene and mixtures thereof.

Representative examples of phthalein acid-base indicators of the present invention include, but are not limited to, carvacrolphthalein, o-cresolphthalein, o-cresolphthalein complexon, dixylenolphthalein, guaiacolphthalein, α-naphtholphthalein, henolphthalein, phenolphthalein, disodium salt, tetrabromophenolphthalein, thymolphthalein, xylenolphthalein and mixtures thereof.

Examples of certain preferred phthalein acid-base indicators include, but are not limited to, as given by the following formula:

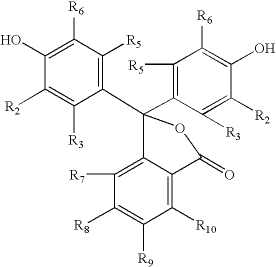

wherein

R₂, R₃, R₅, R₆, R₇, R₈, R₉ R₁₀=H, OH, Cl, Br, I, OR′, CN, NO₂, NH₂, NHR′, NR′R″, NHCOR′, SH, SO₃H, SO₃M, COOH, COOM, alkyl, alkoxy, aryl, cycloalkyl, hetaryl

R′=alkyl

R″=alkyl

M=metal

Examples of certain preferred phthalein acid-base indicator salts (water soluble) include, but are not limited to, as given by the following formula:

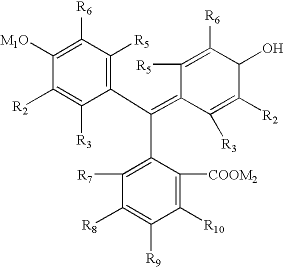

wherein

R₂, R₃, R₅, R₆, R₇, R₈, R₉ R₁₀=H, OH, Cl, Br, I, OR′, CN, NO₂, NH₂, NHR′, NR′R″, NHCOR′, SH, SO₃H, SO₃M, COOH, COOM, alkyl, alkoxy, aryl, cycloalkyl, hetaryl

R′=alkyl

R″=alkyl

M₁, M₂=metal

Representative examples of sulfonephthalein acid-base indicators of the present invention include, but are not limited to, bromochlorophenol blue, bromochlorophenol blue sodium salt, bromocresol green, bromocresol green sodium salt, bromocresol purple, bromocresol purple sodium salt, bromophenol blue, bromophenol blue sodium salt, bromophenol red, bromophenol red sodium salt, bromothymol blue, bromothymol blue sodium salt, bromoxylenol blue, chlorophenol red, chlorophenol red sodium salt, m-cresol purple, m-cresol purple sodium salt, o-cresol red, o-cresol red sodium salt, phenol red, phenol red, sodium salt, thymol blue, xylenol blue and mixtures thereof.

Examples of certain preferred sulfonephthalein acid-base indicators include, but are not limited to, as given by the following formula:

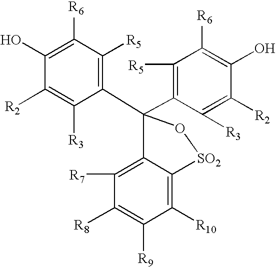

wherein

R₂, R₃, R₅, R₆, R₇, R₈, R₉ R₁₀=H, OH, Cl, Br, I, OR′, CN, NO₂, NH₂, NHR′, NR′R″, NHCOR′, SH, SO₃H, SO₃M, COOH, COOM, alkyl, alkoxy, aryl, cycloalkyl, hetaryl

R′=alkyl

R″=alkyl

M=metal

Examples of certain preferred sulfonephthalein acid-base indicator salts (water soluble) include, but are not limited to, as given by the following formula:

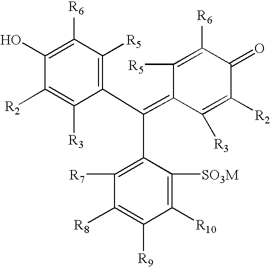

wherein

R₂, R₃, R₅, R₆, R₇, R₈, R₉ R₁₀=H, OH, Cl, Br, I, OR′, CN, NO₂, NH₂, NHR′, NR′R″, NHCOR′, SH, SO₃H, SO₃M, COOH, COOM, alkyl, alkoxy, aryl, cycloalkyl, hetaryl

R′=alkyl

R″=alkyl

M=metal

Representative examples of tripheylmethane acid-base indicators of the present invention include, but are not limited to, acid fuchsin, alkali blue, aurin, crystal violet, ethyl violet, heptamethoxy red, hexamethoxy red, malachite green, methyl green, methyl violet, patent blue V, pentamethoxy red, poirrier blue C 4B, p-rosolic acid, rubrophen and mixtures thereof.

Representative examples of miscellaneous acid-base indicators of the present invention include, but are not limited to, curcumin, hematoxylin, indigo carmine, indophenol, isonitrosothiocamphor, neutral red, phenolmalein, resazurin, alizarin red, alizarin red S, pinachrome, quinaldine red, quinoline blue, anilinesulfonephthalein, benzoflavine, bromopyrogallol red, lacmoid, methyl purple, oxine blue, tobias acid and mixtures thereof.

Additionally, substituted hydrazides based acid-base indicators are useful herein, as given by the general formula:

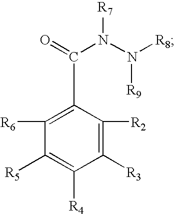

wherein

R₂, R₃, R₅, R₆, R₇, R₈, R₉ R₁₀=H, OH, Cl, Br, I, OR′, CN, NO₂, NH₂, NHR′, NR′R″, NHCOR′, SH, SO₃H, SO₃M, COOH, COOM, alkyl, alkoxy, aryl, cycloalkyl, hetaryl

R′=alkyl

R″=alkyl

Representative examples of biological stains (Certified by Biological Stains Commission, USA) of the present invention include, but are not limited to, acid fuchsin, sodium salt, alcian blue, alizarin red, alizarin red S, aniline blue, auramine O, azure A, azure B, bismark brown Y, brilliant cresyl blue, brilliant green, carmine, congo red, cresyl violet, cresyl violet acetate, crystal violet, darrow red, eosin B, eosin Y, erythosin B, ethyl eosin, fast green FCF, giemsa stain, hematoxylin, indigo carmine, janus green B, jenner stain, light green SF, malachite green, methyl violet 2B, methyl green, methyl orange, methylene blue, neutral red, nigrosin, nile blue A, oil red O, orange G, orange II, orcein, phloxine B, pyronin B, pyronin Y, resazurin, p-rosaniline hydrochloride, rose bengal sodium salt, safranine O, stains all, sudan III, sudan IV, sudan Black B, tetrachrome stain, thionine (acetate), toluidine blue O, wright stain and mixtures thereof.

Suitable optional additives to the compositions of the present invention include, but are not limited to, antimicrobial agents, humectants, thickening agents, moisturizers, chelating agents, preservatives, fragrance, etc.

Representative examples of thickening agents include, but are not limited to, sodium chloride, methyl cellulose, ethyl cellulose, hydroxypropyl cellulose, hydroxyethyl cellulose, carboxymethyl cellulose, xanthum gum, gum Arabic, gum karaya, guar gum, hydroxypropyl guar, carboxymethyl guar, carboxymethy hydroxypropyl guar, locust bean gum, ghatti gum, hydrolyzed starches, gelatin, chitosan and its derivatives, low molecular weight ethylene oxide polymers, low molecular weight propylene oxide polymers, polysulfonic acids and their salts and mixtures thereof.

Representative examples of chelating agents which are capable of protecting and preserving the composition of the present invention include, but are not limited to, ethylene diamine tetraacetic acid (EDTA), tetrasodium EDTA and mixtures thereof.

Representative examples of preservatives include, but are not limited to, glutaraldehyde, bicyclic oxazolidones, hydroxybenzoic acid esters, 3-iodo-2-propynyl butyl carbamate, methyl p-hydroxybenzoate, and a biocide comprising 2-methyl-4-isothiazolin-3-one and 5-chloro-2-methyl-4-isothiazolin-3-one. The preservatives often serve as both a bactericide and a fungicide. In some embodiments, the preferred preservatives include, but are not limited to, Liquid Germall Plus (iodopropynyl butyl carbamate), Germall II (diazolidinyl urea), manufactured by ISP (International Specialty Products), Wayne, N.J.; Troysan 395 (dihydroxy-dimethyl hydantoin), manufactured by Troy Chemical Corporation, Florham, N.J.; and Kathon PFM (isothiazolinones), manufactured by Rohm & Haas Co., Philadelphia, Pa. Pleasant smelling fragrances compatible with soaps may also be added. In addition, the present invention may include the addition of one or more essential oils, aroma compounds, synthetic compound and the like.

The present invention may be include fragrances and aromas from animals including ambergris whose precursors were secreted and expelled by the Sperm Whale, castoreum obtained from the odorous sacs of the beaver, civet musk, honeycomb of the Honeybee, musk sacs from the Asian musk deer, or synthetic musks. Similarly, plants have long been used in perfumery as a source of essential oils and aroma compounds.

An essential oil or hydrophobic liquid containing volatile aroma compounds from plants, which are called aromatic herbs or aromatic plants. They are also known as volatile or ethereal oils, or simply as the “oil of” the plant material from which they were extracted, such as oil of clove. An oil is “essential” in the sense that it carries a distinctive scent, or essence, of the plant. Essential oils do not as a group need to have any specific chemical properties in common, beyond conveying characteristic fragrances. Essential oils used in the present invention include allspice, juniper, almond, anise, celery, cumin, nutmeg oil, cassia, cinnamon, sassafras, camphor, cedar, rosewood, sandalwood, rhizome, ginger, basil, bay leaf, cinnamon, common sage, eucalyptus, lemon grass, melaleuca, oregano, patchouli, peppermint, pine, rosemary, spearmint, tea tree, thyme, wintergreen, frankincense, myrrh, , chamomile, clary, sage, clove, geranium, hyssop, jasmine, lavender, manuka, marjoram, orange, rose, ylang-ylang, bergamot, grapefruit, lemon, lime, orange, tangerine and valerian.

Synthetic aroma compounds include benzyl alcohol (oxidises to benzaldehyde, almond), ethyl maltol (sugary, cooked fruit), furaneol (strawberry), 1-hexanol (herbaceous, woody), cis-3-hexen-1-ol (fresh cut grass), menthol (peppermint), acetaldehyde (pungent), benzaldehyde (marzipan, almond), hexanal (green, grassy), cinnamaldehyde (cinnamon), citral (lemongrass, lemon oil), cis-3-hexenal (green tomatoes), furfural (burnt oats), neral (citrus, lemongrass), vanillin (vanilla), indole (jasmine flowery, feces), skatole (bad breath, feces), substituted pyrazines: 2-ethoxy-3-isopropylpyrazine, 2-methoxy-3-sec-butylpyrazine, 2-methoxy-3-methylpyrazine (toasted seeds of fenugreek, cumin, and coriander), ethyl acetate (fruity, solvent), ethyl butanoate (fruity), ethyl decanoate, ethyl hexanoate, ethyl octanoate, hexyl acetate (apple, floral, fruity), isoamyl acetate (banana), methyl butanoate (apple, fruity), methyl salicylate (oil of wintergreen), pentyl butanoate (pear, apricot), pentyl pentanoate (apple, pineapple), sotolon (maple syrup, curry, fenugreek), strawberry aldehyde (strawberry), fructone (fruity, apple-like), anethole (liquorice, anise seed, ouzo, fennel), anisole (anise seed), eugenol (clove oil), 2,4,6-trichloroanisole (cork taint), oct-1-en-3-one (blood, metallic, mushroom-like)[1], 2-acetyl-1-pyrroline (fresh bread, jasmine rice), 6-acetyl-2,3,4,5-tetrahydropyridine (fresh bread, tortillas, pop corn), camphor (cinnamomum camphora), citronellol (rose), linalool (floral, citrus, coriander), nerol (sweet rose), nerolidol (wood, fresh bark), alpha-terpineol (lilac), thujone (juniper, common sage, nootka cypress, and wormwood), thymol (thyme-like), ethanethiol, formerly called ethyl mercaptan (durian or leek, added to natural gas), grapefruit mercaptan (grapefruit), methanethiol, methylphosphine, dimethylphosphine, nerolin (orange flowers), and tetrahydrothiophene.

### EXAMPLES

The embodiments of the present invention are further illustrated by the following examples. The examples are provided for illustrative purposes only and are not intended nor should they be construed as limiting the scope of this invention in any manner whatsoever.

List of approved colorants: Color additives subject to certification and permanently listed (unless otherwise indicated) for use in FOOD. Most are also listed for use in DRUGS AND COSMETICS as noted. (None of these colors may be used in products that are for use in the area of the eye, unless otherwise indicated).

FD&C Blue #1

FD&C Blue #1

FD&C Blue #2

FD&C Blue #2

FD&C Green #3

FD&C Red #3

FD&C Red #40 and its Aluminum Lake

FD&C Yellow #5

FD&C Yellow #5 Aluminum Lake

FD&C Yellow #6

FD&C Lakes (See Preface of this exhibit)

Citrus Red #2

Color additives subject to certification and permanently listed (unless otherwise indicated) for DRUG AND COSMETIC use. (None of these colors may be used in products that are for use in the area of the eye unless otherwise indicated).

D&C Black #2

D&C Black #3

D&C Green #5

D&C Orange #5

D&C Red #6

D&C Red #7

D&C Red #21

D&C Red #22

D&C Red #27

D&C Red #28

D&C Red #30

D&C Red #33

D&C Red #36

D&C Yellow #10

D&C Lakes (See Preface of this Exhibit)

Color Additives subject to certification and permanently listed (unless otherwise indicated) for use in EXTERNALLY APPLIED DRUGS & COSMETICS. (None of these colors may be used in products that are for use in the area of the eye)

D&C Brown #1 Only external cosmetics

FD&C Red #4

D&C Red #17

D&C Red #31

D&C Red #34

D&C Red #39

D&C Violet #2

Ext. D&C Violet #2

D&C Blue #4

D&C Green #6

D&C Green #8

D&C Yellow #7

Ext. D&C Yellow #7

D&C Yellow #8

D&C Yellow #11

D&C Orange #4

D&C Orange #10

D&C Orange #11

Ext. D&C Lakes (See Preface of this Exhibit)

Color additives exempt from certification and permanently listed for FOOD use.

Algae meal, dried

Annatto extract

Astaxanthin

Beet juice (as vegetable juice)

Beet powder (Dehydrated beets)

Beta

Beta carotene, natural and synthetic

Canthaxanthin

Caramel

Carmine

Carrot oil

Cochineal extract

Corn endosperm oil

Cottonseed flour, toasted partially defatted cooked

Ferrous gluconate

Ferrous lactate

Fruit juice

Grape color extract

Grape skin extract (enocianina)

Haematococcus algae meal

Synthetic iron oxide

Lycopene, tomato extract or concentrate

Mica

Paprika & Paprika oleoresin

Phaffla yeast

Riboflavin

Saffron

Sodium copper chlorophyllin

Tagetes (Aztec marigold) meal and extract

Titanium dioxide

Turmeric & Turmeric oleoresin

Ultramarine blue

Vegetable juice

Color additives exempt from certification and permanently listed for DRUG use. (None of these color additives may be used in products that are for use in the area of the eye, unless otherwise indicated.).

Alumina

Aluminum powder

Annatto extract

Beta

Bismuth oxychloride

Bronze powder

Calcium carbonate

Canthaxanthin

Caramel

Carmine

Chlorophyllin, copper complex

Chromium hydroxide, green

Chromium oxides greens

Cochineal extract

Copper, metallic powder

Potassium sodium copper chlorophyllin (Chlorophyllin copper complex)

Dihydroxyacetone

Ferric ammonium ferrocyanide (Iron Blue)

Ferric ferrocyanide (Iron Blue)

Guanine (Pearl essence)

Mica

Mica

Pyrophyllite

Synthetic iron oxide

Talc

Titanium dioxide

Zinc oxide

Color additives exempt from certification and permanently listed for COSMETIC use. (None of these colors may be used in products that are for use in the area of the eye, unless otherwise indicated)

Aluminum powder

Annatto

Bismuth citrate

Bismuth oxychloride

Bronze powder

Caramel

Carmine

Beta

Chromium hydroxide green

Chromium oxide greens

Copper, metallic powder

Dihydroxyacetone

Disodium EDTA

Ferric ammonium ferrocyanide

Ferric ferrocyanide

Guaiazulene (Azulene)

Guanine (Pearl essence)

Henna

Iron oxides

Lead acetate

Luminescent zinc sulfide

Manganese Violet

Mica

Potassium sodium copper chlorophyllin (Chlorophyllin copper complex)

Pyrophyllite

Silver

Titanium dioxide

Ultramarines (Blue, Green, Pink, Red & Violet)

Zinc oxide

Color additives exempt from certification (unless otherwise indicated) and permanently listed for use in Medical Devices.

1,4-Bis[(2-hydroxyethyl)amino]-9,10-anthracenedione bis(2-propenoic)ester copolymers

1,4-Bis[4-(2-methacryloxyethyl)phenylamino]-9,10-anthraquinone copolymers

1,4-Bis[(2-methylphenyl)amino]-9,10-anthracenedione

Carbazole violet

Chlorophyllin-copper complex

Chromium-cobalt-aluminum oxide

Chromium oxide greens

C.I. Vat Orange 1

7,16-Dichloro-6,15-dihydro-5,9,14,18-anthrazinetetrone

2-[[2,5-Diethoxy-4-[(4-methylphenyl)thiol]phenyl]azo]-1,3,5-benzenetriol

16,23-Dihydrodinaptho[2,3-a:2′,3′-i]napth[2′,3′:6,7]indolo[2,3-c]carbazole-5,10,15,17,22,24-hexone

N,N′-(9,10-Dihydro-9,10-dioxo-1,5-anthracenediyl) bis-benzamide

16,17-Dimethoxydinaptho[1,2,3-cd:3′,2′,1′-lm]perylene-5,10-dione

4-[(2,4-Dimethylphenyl)azo]-2,4-dihydro-5-methyl-2-phenyl-3H-pyrazol-3-one

D&C Blue #6

D&C Blue #9

D&C Green #5

D&C Green #6

D&C Red #17

D&C Violet #2

D&C Yellow #10

6-Ethoxy-2-(6-ethoxy-3-oxobenzo[b]thien-2-(3H)-ylidene)benzo[b]thiophen-3-(2H)-one

FD&C Blue #2

FD&C Blue #2 Aluminum lake on alumina

Iron oxides, synthetic

Ferric ammonium citrate

Logwood extract

Mica-based pearlescent pigments

[Phthalocyaninato(2-)] copper

Phthalocyanine green

Poly(hydroxyethyl methacrylate)-dye copolymers

C.I. Reactive Black 5

C.I. Reactive Blue 4

C.I. Reactive Blue 19

C.I. Reactive Blue 21

C.I. Reactive Blue 163

C.I. Reactive Orange 78

C.I. Reactive Red 11

C.I. Reactive Red 180

C.I. Reactive Yellow 15

C.I. Reactive Yellow 86

Pyrogallol

Titanium dioxide

Vinyl alcohol/methyl methacrylate

C.I. Reactive Black 5

C.I. Reactive Blue 19

C.I. Reactive Blue 21

C.I. Reactive Orange 78

C.I. Reactive Red 180

C.I. Reactive Yellow 15

Many of the sources of natural food colorants contain anthocyanins, which belong to a larger class of compounds called flavonoids. Anthocyanins are composed of aglycone (anthocyanidin), sugar and may also include organic acids and are water soluble pigments that occur naturally in a variety of plants, vegetables, flowers, and grains. Anthocyanins can be found in high levels in plant or plant products such as grape juice, grape skin extract, elderberry, purple carrot, red radish, and red cabbage.

As a group, anthocyanins exhibit diverse color qualities at different pH levels. For example, at a pH of about 3, anthocyanins will exhibit a red color. However, when placed in a more basic environment, at a pH of 8 for example, the anthocyanin may be green or blue. The color intensity of anthocyanins also varies with pH, with the highest color intensity exhibited at pH values less than 4.

Although generally more expensive than other sources of anthocyanins, red cabbage extracts are often used in natural colorants. Red cabbage has about fifteen anthocyanins that have cyanidin as the aglycone and glucose as the sugar. Red cabbage anthocyanins include the organic acids ferulic and coumaric to produce acylated anthocyanins. As compared to most other anthocyanin extracts, the red cabbage extract shows improved stability when exposed to heat or light.

Generally the present invention may include anthocyanins, which are generally water-soluble vacuolar pigments synthesized via the phenylpropanoid pathway and are in a class of molecules called flavonoids. The anthocyanins may appear red, purple, or blue, according to pH. Many anthocyanins are synthesized by organisms in the plant kingdom, and have been observed to occur in all tissues of higher plants, including leaves, stems, roots, flowers, and fruits. Anthocyanins are found in many cells and are the glycosides of cyanidin, delphinidin, malvidin, pelargonidin, peonidin and petunidin.

For example, cyanidin is a natural organic compound. It is a particular type of anthocyanidin (not to be confounded with anthocyanins which are glycosides of anthocyanidins). It is a pigment found in many redberries including but not limited to grapes, bilberry, blackberry, blueberry, cherry, cranberry, elderberry, hawthorn, loganberry, acai berry, raspberry, apples and plums. Furthermore, the biosynthesis of cyanidin 3-O-glucoside was demonstrated in Escherichia coli.

Delphinidin is an anthocyanidin, and a primary plant pigment. Delphinidin gives blue hues to flowers like violas and delphiniums. It also gives the blue-red color of the grape that produces Cabernet Sauvignon, and can be found in cranberries and Concord grapes.

Malvidin is an anthocyanidin. It is primarily responsible for the color of red wine, Vitis vinifera being one of its sources and it is also responsible for the blue pigment found in the Primula polyanthus plant. Slightly acidic and neutral solutions of malvidin are characteristically of a red color, while basic solutions of malvidin yield a blue color.

The pigment components of anthocyanidins, the sugar-free anthocyanins, can be identified based on the structure of a large group of polymethine dye, the benzopyrylium (chromenylium) ion. In particular anthocyanidins are salt derivatives of the 2-phenylchromenylium cation also known as flavylium cation.

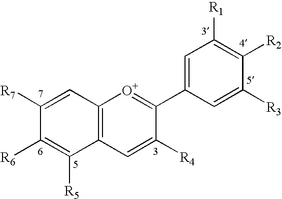

The phenyl group at the 2-position, can carry different substituents. The counterion of the flavylium cation is mostly chloride. With this positive charge the anthocyanins differ from other flavonoids. The anthocyanins, anthocyanidins with sugar group, are mostly 3-glucosides of the anthocyanidins. The anthocyanins are subdivided into the sugar-free anthocyanidin aglycones and the anthocyanin glycosides. The skilled artisan knows that there are more than 550 different anthocyanins. The difference in chemical structure that occurs in response to changes in pH and is the reason why anthocyanins are often used as pH indicator, as they change from red in acids to blue in bases.

Given the general structure listed above numerous compounds may be formed through varying the R groups. For example:

| Anthocyanidin | R1 | R2 | R3 | R4 | R5 | R6 | R7 |
|---|---|---|---|---|---|---|---|
| Aurantinidin | —H | —OH | —H | —OH | —OH | —OH | —OH |
| Cyanidin | —OH | —OH | —H | —OH | —OH | —H | —OH |
| Delphinidin | —OH | —OH | —OH | —OH | —OH | —H | —OH |
| Europinidin | —OCH₃ | —OH | —OH | —OH | —OCH₃ | —H | —OH |
| Luteolinidin | —OH | —OH | —H | —H | —OH | —H | —OH |
| Pelargonidin | —H | —OH | —H | —OH | —OH | —H | —OH |
| Malvidin | —OCH₃ | —OH | —OCH₃ | —OH | —OH | —H | —OH |
| Peonidin | —OCH₃ | —OH | —H | —OH | —OH | —H | —OH |
| Petunidin | —OH | —OH | —OCH₃ | —OH | —OH | —H | —OH |
| Rosinidin | —OCH₃ | —OH | —H | —OH | —OH | —H | —OCH₃ |

The edible pH indicator includes any substance that changes color in response to the pH of the solution it is dissolved in. Edible indicators are non-toxic when consumed in amounts that are effective for detecting color changes due to pH variations. The pH indicator may be responsive to narrow or broad pH ranges, and may be show the greatest colorimetric response at alkaline pH ranges, acidic pH ranges, or neutral pH ranges. Particularly useful pH indicators for use in the instant beverage composition include anthocyanins. Anthocyanins are typically present in extracts of red cabbage, such as red cabbage juice, or red cabbage powder. Such extracts of red cabbage are a particularly useful edible pH indicator for inclusion in the first mixture. Red cabbage extracts are typically blue or green at high pH levels (more basic) purple at neutral pH levels, and pink to red at low pH levels (more acidic).

In addition, the present invention may also include coloring agents may include any of a variety of natural or artificial food colorings that are non-toxic and known in the art, including Red no. 2 (amaranth), Red no. 3 (erythrosine), Red no. 4 (Ponceau SX), DC Red no. 22 (eosine), Red no. 28 (phloxine), Red no. 40 (Allura Red; or disodium salt of 6-hydroxy-5[(2-methoxy-5-methyl-4-sulfop-henyl) azo]-2-naphthalenesulfonic acid), Yellow no. 5 (tartrazine; trisodium 5-hydroxy-1-(4-sulfonatophenyl) (4-sulfonatophenylazo)-H-pyrazo-1e-3-carboxylate), DC Yellow no. 1 (quinoline yellow SS), Yellow no. 6 (Sunset Yellow FCF; or disodium salt of 6-hydroxy-5-[(4-sulfophenyl)azo]-2-naphthalenesulfonic acid)), DC Yellow no. 10 (Quinoline Yellow WS), Green no. 3 (Fast Green FCF), DC Green no. 5 (Alizarine Cyanine Green F), DC Green no. 6 (Quinizarine Green SS), Blue no. 1 (Brilliant Blue FCF), Blue no. 2 (Indigo Carmine), annatto, anthocyanins, beet extracts, beta-carotene, caramel, carmine/cochineal, paprika oleoresin, and turmeric, among others. In one embodiment of the invention, the coloring agents include one or more of anthocyanins, and Yellow no. 5.

### Example 1

| | |
|---|---|
| Stepanol ABHS-15C | 20 g |
| o-Cresolphthalein | 0.5 g |
| Sodium hydroxide | 0.11 g |
| DI water | 77.79 g |
| Sodium chloride | 1.5 g |
| Preservative | 0.1 g |

A mixture of Stepanol ABHS-15C, fragrance and DI water was stirred until homogeneous. o-Cresolphthalein was added to the mixture followed by addition of sodium hydroxide. The viscosity was adjusted by addition of sodium chloride. Preservative was added and the mixture was stirred for 2 hours (preferably overnight).

### Example 2

| | |
|---|---|
| Stepanol DCFAS-F/N | 3.5 g |
| Ninol 40CO | 1 g |
| o-Cresolphthalein | 0.5 g |
| Sodium hydroxide | 0.11 g |
| DI water | 93.29 g |
| Sodium chloride | 1.5 g |
| Preservative | 0.1 g |

A mixture of Stepanol DCFAS-F/N in DI water was stirred until completely dissolved and homogeneous followed by addition of Ninol 40CO. o-Cresolphthalein was added to the mixture followed by addition of sodium hydroxide. The viscosity was adjusted by addition of sodium chloride. Preservative was added and the mixture was stirred for 2 hours (preferably overnight).

### Example 3

| | |
|---|---|
| Bio-Terge AS-40 | 15.4 g |
| Steol CS-460 | 9 g |
| Amphosol CA | 4 g |
| Ninol 40-CO | 1 g |
| Thymolphthalein | 0.5 g |
| Sodium hydroxide | 0.09 g |
| DI water | 68.41 g |
| Sodium chloride | 1.5 g |
| Preservative | 0.1 g |

A mixture of Bio-Terge AS-40 in DI water was stirred until homogeneous followed by addition of Steol CS-460, Amphosol CA and Ninol 40-CO. Thymolphthalein was added to the mixture followed by addition of sodium hydroxide. The viscosity was adjusted by addition of sodium chloride. Preservative was added and the mixture was stirred for 2 hours (preferably overnight).

### Example 4

| | |
|---|---|
| Bio-Terge AS-40 | 15.4 g |
| Steol CS-460 | 9 g |
| Amphosol CA | 4 g |
| Ninol 40-CO | 1 g |
| o-Cresolphthalein | 0.5 g |
| Sodium hydroxide | 0.11 g |
| DI water | 68.49 g |
| Sodium chloride | 1.5 g |
| Preservative | 0.1 g |

A mixture of Bio-Terge AS-40 in DI water was stirred until homogeneous followed by addition of Steol CS-460, Amphosol CA and Ninol 40-CO. o-Cresolphthalein was added to the mixture followed by addition of sodium hydroxide. The viscosity was adjusted by addition of sodium chloride. Preservative was added and the mixture was stirred for 2 hours (preferably overnight).

### Example 5

| | |
|---|---|
| Amphosol HCA | 4 g |
| Steol CS-330 | 10 g |
| Ninol 40-CO | 0.5 g |
| o-Cresolphthalein | 0.5 g |
| Sodium hydroxide | 0.11 g |
| DI water | 83.29 g |
| Sodium chloride | 1.5 g |
| Preservative | 0.1 g |

A mixture of Amphosol HCA in DI water was stirred until homogeneous followed by addition of Steol CS-330 and Ninol 40-CO. o-Cresolphthalein was added to the mixture followed by addition of sodium hydroxide. The viscosity was adjusted by addition of sodium chloride. Preservative was added and the mixture was stirred for 2 hours (preferably overnight).

### Example 6

| | |
|---|---|
| Cola Terric SLAA | 42.8 g |
| Colamid AL | — |
| Cola Lipid C | 2 g |
| Thymolphthalein | 0.5 g |
| Sodium hydroxide | 0.09 g |
| DI water | 53.01 g |
| Sodium chloride | 1.5 g |
| Preservative | 0.1 g |

A mixture of Cola Terric SLAA, Cola Lipid C and DI water was stirred until homogeneous. Thymolphthalein was added to the mixture followed by addition of sodium hydroxide. The viscosity was adjusted by addition of sodium chloride. Preservative was added and the mixture was stirred for 2 hours (preferably overnight).

### Example 7

| | |
|---|---|
| Colonial SLS | 20.00 g |
| Colamid AL | 0.5 g |
| o-Cresolphthalein | 0.5 g |
| Sodium hydroxide | 0.11 g |
| DI water | 77.29 g |
| Sodium chloride | 1.5 g |
| Preservative | 0.1 g |

A mixture of Colonial SLS, Colamid AL in DI water was stirred until homogeneous. o-Cresolphthalein was added to the mixture followed by addition of sodium hydroxide. The viscosity was adjusted by addition of sodium chloride. Preservative was added and the mixture was stirred for 2 hours (preferably overnight).

### Example 8

| | |
|---|---|
| Bio-Terge AS-40 | 15.4 g |
| Steol CS-460 | 9 g |
| Amphosol CA | 4 g |
| Ninol 40-CO | 1 g |
| Fluorescein | 0.2 g |
| Sodium hydroxide | 0.05 g |
| DI water | 68.75 g |
| Sodium chloride | 1.5 g |
| Preservative | 0.1 g |

A mixture of Bio-Terge AS-40 in DI water was stirred until homogeneous followed by addition of Steol CS-460, Amphosol CA and Ninol 40-CO. Fluorescein was added to the mixture followed by addition of sodium hydroxide. The viscosity was adjusted by addition of sodium chloride. Preservative was added and the mixture was stirred for 2 hours (preferably overnight).

### Example 9

| | |
|---|---|
| Colonial SLS | 20.00 g |
| Colamid AL | 0.5 g |
| Peonidin HCl | 0.010 g |
| Sodium hydroxide | 0.11 g |
| DI water | 77.29 g |
| Sodium chloride | 1.5 g |
| Preservative | 0.1 g |

A mixture of Colonial SLS, Colamid AL in DI water was stirred until homogeneous. Peonidin.HCl was added to the mixture followed by addition of sodium hydroxide. The viscosity was adjusted by addition of sodium chloride. Preservative was added and the mixture was stirred for 2 hours (preferably overnight).

### Example 10

| | |
|---|---|
| Colonial SLS | 20.00 g |
| Colamid AL | 0.5 g |
| Dye | 0.100 g |
| Sodium hydroxide | 0.11 g |
| DI water | 77.29 g |
| Sodium chloride | 1.5 g |
| Preservative | 0.1 g |

A mixture of Colonial SLS, Colamid AL in DI water was stirred until homogeneous. The dye [one of the following] D&C Red No 6, D&C Red No 33, D&C Orange No 4, FD&C Yellow No 5, FD&C Red No 40, Food Yellow 1, FD&C Yellow No 6 (Sunset Yellow FCF), Sudan III (D&C Red No 17), FD&C Blue no 2, Curcumin, D&C Yellow No 10, FD&C Green No 3, D&C blue no 4, Chrome Azurol S, D&C Blue No 4, FD&C Blue No 1, Food Blue 3, FD&C Green No 1, was added to the mixture followed by addition of analyte [one of the following: cupric acetate, zinc aceate, calcium acetate, magnesium acetate, sodium carbonate, or potassium carbonate. Preservative was added and the mixture was stirred for 2 hours (preferably overnight).

### Example 11

| | | |
|---|---|---|
| Colonial SLS | 20.00 | g |
| Colamid AL | 0.5 | g |
| Dye | 0.100 | g |
| Sodium hydroxide | 0.11 | g |
| DI water | 77.29 | g |
| Sodium chloride | 1.5 | g |
| Preservative | 0.1 | g |

A mixture of Colonial SLS, Colamid AL in DI water was stirred until homogeneous. The dye [one of the following] D&C Red No 6, D&C Red No 33, D&C Orange No 4, FD&C Yellow No 5, FD&C Red No 40, Food Yellow 1, FD&C Yellow No 6 (Sunset Yellow FCF), Sudan III (D&C Red No 17), FD&C Blue no 2, Curcumin, D&C Yellow No 10, FD&C Green No 3, D&C blue no 4, Chrome Azurol S, D&C Blue No 4, FD&C Blue No 1, Food Blue 3, FD&C Green No 1, was stirred in the presence of the cationic surfactant cetyl ammonium bromide, then was added to the mixture followed by addition of analyte [one of the following: cupric acetate, zinc acetate, calcium acetate, magnesium acetate, sodium carbonate, or potassium carbonate. Preservative was added and the mixture was stirred for 2 hours (preferably overnight).

### Example 12

| | | |
|---|---|---|
| Colonial SLS | 20.00 | g |
| Colamid AL | 0.5 | g |
| Dye | 0.100 | g |
| Sodium hydroxide | 0.11 | g |
| DI water | 77.29 | g |
| Sodium chloride | 1.5 | g |
| Preservative | 0.1 | g |

A mixture of Colonial SLS, Colamid AL in DI water was stirred until homogeneous. The dye [one of the following] D&C Red No 6, D&C Red No 33, D&C Orange No 4, FD&C Yellow No 5, FD&C Red No 40, Food Yellow 1, FD&C Yellow No 6 (Sunset Yellow FCF), Sudan III (D&C Red No 17), FD&C Blue no 2, Curcumin, D&C Yellow No 10, FD&C Green No 3, D&C blue no 4, Chrome Azurol S, D&C Blue No 4, FD&C Blue No 1, Food Blue 3, FD&C Green No 1, was stirred in the presence of the cationic surfactant cetyl ammonium bromide, then was added to the mixture followed by addition of analyte [one of the following: cupric acetate, zinc aceate, calcium acetate, magnesium acetate, sodium carbonate, or potassium carbonate. An encapsulated metal deactivator, added as a microcapsule was added to the mixture. Preservative was added and the mixture was stirred for 2 hours (preferably overnight).

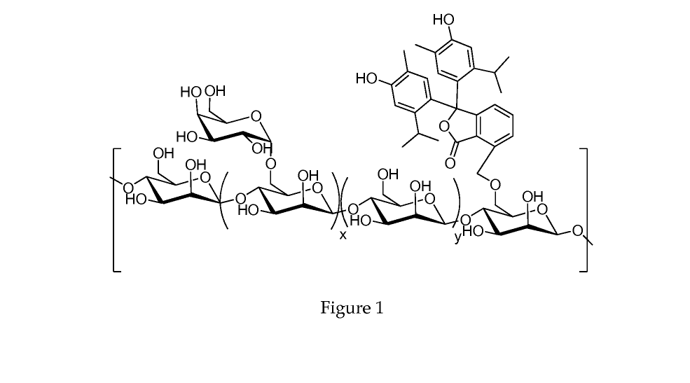

FIG. 1 shows an example of a dye attached to a biopolymer (in this case, guar gum). Other examples of To verify the dye was attached to the polymer, and that its properties were altered, thymolphthalein attached to the polymer was subjected to extractions by dichloromethane from alkaline and acidic aqueous solvents. Neutral thymolpthalein readily extracts into dichloromethane, and under both conditions it was observed that the transport of this unattached dye depended upon the pH to which was it was preferentially located. TLC (thin layer chromatography) was used to qualitatively follow the phase of the dye. On the other hand, when the dye was attached to the highly water soluble polymer, its phase transfer properties were altered, and the product remained in the aqueous phase, regardless of pH, but would change the water phase to blue at higher pH's. TLC was used to look for unattached dye, but none was observed. These results confirm the dye was attached to the polymer, it's solubility properties were altered, but not its color changing properties. One skilled in the art recognizes the dye follows the water soluble polymer, preventing its absorption through the skin, or the staining of clothes.

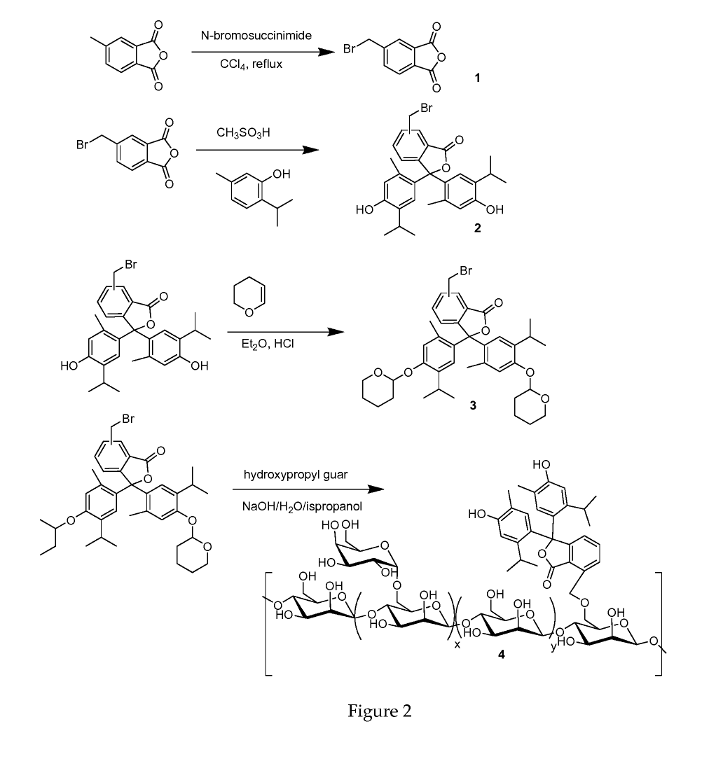

FIG. 2 details the chemical reactions and protocol for attaching a dye to a biopolymer. Step 1. The bromomethyl phthalicanhydride was prepared from N-bromosuccinimide, benzoyl peroxide in carbon tetrachloride at reflux. The product 1 was isolated in a yield of 67%. Step 2. The phthalein class dye was synthesized from reaction of the product 1 with thymol in methanesulfonic acid yielding a product consistent with its structure by NMR. Step 3. To minimize side reactions upon coupling with hydroxypropyl guar, 2 was transformed into its corresponding bistetrahydropyranyl ether to prevent undesired side reactions. This protection group provides for facile removal in the presence of acid, but is stable under alkaline conditions. Subsequent work has shown the effect of the protecting group may be mitigated through the addition of the reactive bromomethyl phthalein dropwise, very slowly. One skilled in the art would recognize a number of alcohol protecting groups could be selected under the conditions of these reactions. Step 4. The final coupling reaction was performed using an alcoholic mixture of 20% isopropanol in water. This was accomplished by adding an alcohol solution of the dye to the hydrated, solvated guar in the presence of base. One skilled in the art would recognize the choice of base would include all that have pKa that allows it to react with the guar biopolymer.

The following cleansing mixtures were formulated. These results of the combinations were recorded, as listed following the formulations.

Formulation-1C

| | | |
|---|---|---|
| Stepanol ABHS-15C | 20 | g |
| Thymolphthalein | 0.5 | g |
| Sodium hydroxide | 0.09 | g |
| DI water | 77.81 | g |
| Sodium chloride | 1.5 | g |
| Preservative | 0.1 | g |
| Fragrance | | |

A mixture of Stepanol ABHS-15C, fragrance and DI water was stirred until homogeneous. Thymolphthalein was added to the mixture followed by addition of sodium hydroxide. The viscosity was adjusted by addition of sodium chloride. Preservative was added and the mixture was stirred for 2 hours (preferably overnight).

Formulation-1D

| | | |
|---|---|---|
| Stepanol ABHS-15C | 20 | g |
| o-Cresolphthalein | 0.5 | g |
| Sodium hydroxide | 0.11 | g |
| DI water | 77.79 | g |
| Sodium chloride | 1.5 | g |
| Preservative | 0.1 | g |
| Fragrance | | |

A mixture of Stepanol ABHS-15C, fragrance and DI water was stirred until homogeneous. o-Cresolphthalein was added to the mixture followed by addition of sodium hydroxide. The viscosity was adjusted by addition of sodium chloride. Preservative was added and the mixture was stirred for 2 hours (preferably overnight).

Formulation-2C

| | | |
|---|---|---|
| Stepanol DCFAS-F/N | 3.5 | g |
| Ninol 40CO | 1 | g |
| Thymolphthalein | 0.5 | g |
| Sodium hydroxide | 0.09 | g |
| DI water | 93.31 | g |
| Sodium chloride | 1.5 | g |
| Preservative | 0.1 | g |
| Fragrance | | |

A mixture of Stepanol DCFAS-F/N in DI water was stirred until completely dissolved and homogeneous followed by addition of Ninol 40CO. Thymolphthalein was added to the mixture followed by addition of sodium hydroxide. The viscosity was adjusted by addition of sodium chloride. Fragrance and preservative was added and the mixture was stirred for 2 hours (preferably overnight).

Formulation-2D

| | | |
|---|---|---|
| Stepanol DCFAS-F/N | 3.5 | g |
| Ninol 40CO | 1 | g |
| o-Cresolphthalein | 0.5 | g |
| Sodium hydroxide | 0.11 | g |
| DI water | 93.29 | g |
| Sodium chloride | 1.5 | g |
| Preservative | 0.1 | g |
| Fragrance | | |

A mixture of Stepanol DCFAS-F/N in DI water was stirred until completely dissolved and homogeneous followed by addition of Ninol 40CO. o-Cresolphthalein was added to the mixture followed by addition of sodium hydroxide. The viscosity was adjusted by addition of sodium chloride. Fragrance and preservative was added and the mixture was stirred for 2 hours (preferably overnight).

Formulation-3C

| | | |
|---|---|---|
| Bio-Terge AS-40 | 15.4 | g |
| Steol CS-460 | 9 | g |
| Amphosol CA | 4 | g |
| Ninol 40-CO | 1 | g |
| Thymolphthalein | 0.5 | g |
| Sodium hydroxide | 0.09 | g |
| DI water | 68.41 | g |
| Sodium chloride | 1.5 | g |
| Preservative | 0.1 | g |
| Fragrance | | |

A mixture of Bio-Terge AS-40 in DI water was stirred until homogeneous followed by addition of Steol CS-460, Amphosol CA and Ninol 40-CO. Thymolphthalein was added to the mixture followed by addition of sodium hydroxide. The viscosity was adjusted by addition of sodium chloride. Fragrance and preservative was added and the mixture was stirred for 2 hours (preferably overnight).

Formulation-3D

| | | |
|---|---|---|
| Bio-Terge AS-40 | 15.4 | g |
| Steol CS-460 | 9 | g |
| Amphosol CA | 4 | g |
| Ninol 40-CO | 1 | g |
| o-Cresolphthalein | 0.5 | g |
| Sodium hydroxide | 0.11 | g |
| DI water | 68.49 | g |
| Sodium chloride | 1.5 | g |
| Preservative | 0.1 | g |
| Fragrance | | |

A mixture of Bio-Terge AS-40 in DI water was stirred until homogeneous followed by addition of Steol CS-460, Amphosol CA and Ninol 40-CO. o-Cresolphthalein was added to the mixture followed by addition of sodium hydroxide. The viscosity was adjusted by addition of sodium chloride. Fragrance and preservative was added and the mixture was stirred for 2 hours (preferably overnight).

Formulation-4C

| | | |
|---|---|---|
| Amphosol HCA | 4 | g |
| Steol CS-330 | 10 | g |
| Ninol 40-CO | 0.5 | g |
| Thymolphthalein | 0.5 | g |
| Sodium hydroxide | 0.09 | g |
| DI water | 83.31 | g |
| Sodium chloride | 1.5 | g |
| Preservative | 0.1 | g |
| Fragrance | | |

A mixture of Amphosol HCA in DI water was stirred until homogeneous followed by addition of Steol CS-330 and Ninol 40-CO. Thymolphthalein was added to the mixture followed by addition of sodium hydroxide. The viscosity was adjusted by addition of sodium chloride. Fragrance and preservative was added and the mixture was stirred for 2 hours (preferably overnight).

Formulation-4D

| | | |
|---|---|---|
| Amphosol HCA | 4 | g |
| Steol CS-330 | 10 | g |
| Ninol 40-CO | 0.5 | g |
| o-Cresolphthalein | 0.5 | g |
| Sodium hydroxide | 0.11 | g |
| DI water | 83.29 | g |
| Sodium chloride | 1.5 | g |
| Preservative | 0.1 | g |
| Fragrance | | |

A mixture of Amphosol HCA in DI water was stirred until homogeneous followed by addition of Steol CS-330 and Ninol 40-CO. o-Cresolphthalein was added to the mixture followed by addition of sodium hydroxide. The viscosity was adjusted by addition of sodium chloride. Fragrance and preservative was added and the mixture was stirred for 2 hours (preferably overnight).

Formulation-6B

| Cola Terric SLAA | 42.8 | g |
|---|---|---|
| Colamid AL | — | |
| Cola Lipid C | 2 | g |
| Thymolphthalein | 0.5 | g |
| Sodium hydroxide | 0.09 | g |
| DI water | 53.01 | g |
| Sodium chloride | 1.5 | g |
| Preservative | 0.1 | g |
| Fragrance | | |

A mixture of Cola Terric SLAA, Cola Lipid C and DI water was stirred until homogeneous. Thymolphthalein was added to the mixture followed by addition of sodium hydroxide. The viscosity was adjusted by addition of sodium chloride. Fragrance and preservative was added and the mixture was stirred for 2 hours (preferably overnight).

Formulation-8A

| | | |
|---|---|---|
| Colonial SLS | 20.00 | g |
| Colamid AL | 0.5 | g |
| Thymolphthalein | 0.5 | g |
| Sodium hydroxide | 0.09 | g |
| DI water | 77.31 | g |
| Sodium chloride | 1.5 | g |
| Preservative | 0.1 | g |
| Fragrance | | |

A mixture of Colonial SLS, Colamid AL in DI water was stirred until homogeneous. Thymolphthalein was added to the mixture followed by addition of sodium hydroxide. The viscosity was adjusted by addition of sodium chloride. Fragrance and preservative was added and the mixture was stirred for 2 hours (preferably overnight).

Formulation-8B

| | | |
|---|---|---|
| Colonial SLS | 20.00 | g |
| Colamid AL | 0.5 | g |
| o-Cresolphthalein | 0.5 | g |
| Sodium hydroxide | 0.11 | g |
| DI water | 77.29 | g |
| Sodium chloride | 1.5 | g |
| Preservative | 0.1 | g |
| Fragrance | | |

A mixture of Colonial SLS, Colamid AL in DI water was stirred until homogeneous. o-Cresolphthalein was added to the mixture followed by addition of sodium hydroxide. The viscosity was adjusted by addition of sodium chloride. Fragrance and preservative was added and the mixture was stirred for 2 hours (preferably overnight).

Formulation-11A

| | | |
|---|---|---|
| Bio-Terge AS-40 | 15.4 | g |
| Steol CS-460 | 9 | g |
| Amphosol CA | 4 | g |
| Ninol 40-CO | 1 | g |
| Fluorescein | 0.2 | g |
| Sodium hydroxide | 0.05 | g |
| DI water | 68.75 | g |
| Sodium chloride | 1.5 | g |
| Preservative | 0.1 | g |
| Fragrance | | |

A mixture of Bio-Terge AS-40 in DI water was stirred until homogeneous followed by addition of Steol CS-460, Amphosol CA and Ninol 40-CO. Fluorescein was added to the mixture followed by addition of sodium hydroxide. The viscosity was adjusted by addition of sodium chloride. Fragrance and preservative was added and the mixture was stirred for 2 hours (preferably overnight).

Cleanser mixture: Formulations listed with “A”: Surfactants mixed followed by addition of DI water and dye. Formulation listed with “B”: First surfactant stirred in water till homogeneous and then each surfactant dissolved in DI water followed by addition of dye. (Order of addition changed). Formulation listed with “C”: Surfactant amount reduced (Amount of component reduced). Formulation listed with “D”: Same as formulation C but different dye was used:

Time to Color Change:

| | |
|---|---|
| 1C | Result: 1-2 sec., Very light color |
| 1D | Result: 3 sec. |
| 2C | Result: 2 sec., Light color |
| 2D | Result: 5 sec. |
| 3C | Result: 5 sec., Good lather (foaming) |
| 3D | Result: 7-8 sec., Better foaming |
| 4C | Result: 4 sec. |
| 4D | Result: 6 sec., Rinse water colored |
| 6B | Result: 8 sec. |
| 8A | Result: 2-3 sec. |
| 8B | Result: 10 sec, Rinse water colored |
| 11A | Result: Intense green fluorescent water |

Color Strategies: Colored to colorless formulations demonstrated. Non-fluorescent to green (colored) fluorescent formulation demonstrated.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1 A nontoxic color changing cleanser composition comprising:
a cleanser mixture comprising a first component mixture and a second component mixture, wherein the first component mixture comprises a nontoxic color changing dye and the first component mixture in combination with the second component mixture such that the color of the nontoxic color changing dye is of a different color than the nontoxic color changing dye in the first component mixture.

2. The composition of claim 1, wherein the pH is different in the first component mixture in combination with the second component mixture than in the pH in the first component mixture.

3. The composition of claim 1, wherein an analyte concentration is different in the first component mixture in combination with the second component mixture than in the first component mixture.

4. The composition of claim 1, wherein the nontoxic color changing dye is an anthocyanin compound.

5. The composition of claim 1, further comprising an antibacterial composition, an antimicrobial compound, an antibiotic, a lipid composition, nanoparticles, metals, or mixtures thereof.

6. The composition of claim 1, wherein the cleanser mixture changes its color due to a decrease in pH upon exposure to atmospheric carbon dioxide.

7. The composition of claim 1, wherein the cleanser mixture further comprising one or more surfactants in contact with the dye, wherein the one or more surfactants are selected to change the speed of a color change in the dye.

8. The composition of claim 1, wherein the cleanser mixture further comprising one or more surfactants in contact with the dye, wherein the surfactant and dye form a mixture that comprises supramolecular complexes that controls the rate through which the absorbance of the dye changes.

9. The composition of claim 1, further comprising a metal ion, wherein the color of the dye is different in the presence of the metal ion.

10. The composition of claim 1, wherein the cleanser mixture comprises at least one color reversible dye, wherein the dye color is reduced in the presence of a metal ion and the color change is controlled by one or more chelating agents that chelate the metal ion.

11. The composition of claim 10, wherein the chelating agent is at least one of EGTA, EDTA or encapsulated EDTA.

12. The composition of claim 10, wherein the color of the cleanser mixture is restored by removing the metal upon release or activation of a chelator.

13. The composition of claim 10, wherein the dye activates in the presence of one or more analytes that shifts the absorbance of the dye, wherein the analyte is selected from small organic molecules that may be positive, negative, neutral of zwitterionic.

14. The composition of claim 1, wherein the first or the second composition further comprise a biopolymer, wherein a toxicity of the dye is reduced by chemical attachment to the biopolymer.

15. The composition of claim 1, wherein the toxicity of the dye is reduced by chemical attachment to a biopolymer.

16. A nontoxic color changing cleanser kit comprising:
a first component mixture; and
a second component mixture, wherein the first component mixture comprises a nontoxic color changing dye and the first component mixture in combination with the second component mixture such that the color of the nontoxic color changing dye is of a different color than the nontoxic color changing dye in the first component mixture.

17. A color changing cleanser composition comprising:
a cleanser having a calorimetric dye disposed therein, wherein the pH affects the color of the calorimetric dye and a change in the pH results in a change in the color of the calorimetric dye.

18. A nontoxic color changing cleanser composition comprising:
a cleanser mixture comprising a first component mixture and a second component mixture, wherein the first component mixture comprises an nontoxic color changing anthocyanin dye and the first component mixture in combination with the second component mixture such that the color of the nontoxic color changing anthocyanin dye is of a different color than the nontoxic color changing anthocyanin dye in the first component mixture.

19. The composition of claim 18, wherein the pH is different in the first component mixture in combination with the second component mixture than in the pH in the first component mixture.

20. A method of forming a nontoxic color changing cleanser composition comprising the steps:
providing a cleanser mixture comprising a first component mixture and a second component mixture; and
mixing the first component mixture and the second component mixture, wherein the first component mixture comprises a nontoxic color changing dye and the first component mixture in combination with the second component mixture such that the color of the nontoxic color changing dye is of a different color than the nontoxic color changing dye in the first component mixture.

21. The method of claim 20, wherein the pH is different in the first component mixture in combination with the second component mixture than in the pH in the first component mixture.

22. The method of claim 20, wherein an analyte concentration is different in the first component mixture in combination with the second component mixture than in the first component mixture.

23. The method of claim 20, wherein the nontoxic color changing dye is an anthocyanin compound.

24. The method of claim 20, further comprising an antibacterial composition, an antimicrobial compound, an antibiotic, a lipid composition, nanoparticles, metals, or mixtures thereof.

25. The composition of claim 20, wherein the cleanser mixture changes its color due to a decrease in pH upon exposure to atmospheric carbon dioxide.

26. The composition of claim 20, wherein the cleanser mixture further comprising one or more surfactants in contact with the dye, wherein the one or more surfactants are selected to change the speed of a color change in the dye.

27. The composition of claim 20, wherein the cleanser mixture further comprising one or more surfactants in contact with the dye, wherein the surfactant and dye form a mixture that comprises supramolecular complexes that controls the rate through which the absorbance of the dye changes.

28. The composition of claim 20, further comprising a metal ion, wherein the color of the dye is different in the presence of the metal ion.

29. The composition of claim 20, wherein the cleanser mixture comprises at least one color reversible dye, wherein the dye color is reduced in the presence of a metal ion and the color change is controlled by one or more chelating agents that chelate the metal ion.

30. The composition of claim 29, wherein the chelating agent is at least one of EGTA, EDTA or encapsulated EDTA.

31. The composition of claim 29, wherein the color of the cleanser mixture is restored by removing the metal upon release or activation of a chelator.

32. The composition of claim 29, wherein the dye activates in the presence of one or more analytes that shifts the absorbance of the dye, wherein the analyte is selected from small organic molecules that may be positive, negative, neutral of zwitterionic.

33. A method of making a nontoxic color changing cleanser composition comprising making a cleanser mixture comprising:
mixing separately a first component mixture and a second component mixture, wherein the first component mixture comprises a nontoxic color changing dye and the first component mixture in combination with the second component mixture such that the color of the nontoxic color changing dye is of a different color than the nontoxic color changing dye in the first component mixture, wherein upon contact between the first and second component the cleanser mixture changes color.
